(19) United States
(12) Patent Application Publication
(10) Pub. No.: US 2025/0226898 A1
(43) Pub. Date: Jul. 10, 2025

(54) METHODS AND ARRANGEMENTS FOR CROSS-LINK INTERFERENCE MITIGATION

(71) Applicant: Intel Corporation, Santa Clara, CA (US)

(72) Inventors: GANG XIONG, Portland, OR (US); DEBDEEP CHATTERJEE, San Jose, CA (US); YI WANG, Beijing (CN); YINGYANG LI, Beijing (CN); SALVATORE TALARICO, Sunnyvale, CA (US)

(73) Assignee: Intel Corporation, Santa Clara, CA (US)

(21) Appl. No.: 18/850,916

(22) PCT Filed: Apr. 26, 2023
(86) PCT No.: PCT/US23/19927

§ 371 Date: Sep. 25, 2024

Related U.S. Application Data
(60) Provisional application No. 63/347,906, filed on Jun. 1, 2022.
(60) Provisional application No. 63/334,928, filed on Apr. 26, 2022.

(51) Int. Cl. H04B 17/345; H04L 5/00; H04W 24/10

(52) U.S. Cl. CPC H04B 17/345; H04L 5/0048; H04W 24/10

(57) ABSTRACT

Logic may send information on cross-link interference reference signal (CLI-RS) resource and measurement configuration via an interface to a second base station, the CLI-RS resource and measurement configuration to comprise an identification of a communication resource within which to measure the CLI-RS. Logic may cause transmission of the CLI-RS. Logic may receive the CLI-RS measurement report based on measurement of the CLI-RS based on a definition for a CLI-RS measurement report from the second base station via the interface. Logic may decode information on CLI-RS resource and measurement configuration received via the interface from a first base station. Logic may measure the CLI-RS based on identification of the communication resource. Logic may generate the CLI-RS measurement report based on measurement of the CLI-RS. And logic may send the CLI-RS measurement report to the first base station.

### CROSS REFERENCE TO RELATED APPLICATIONS

This application claims priority under 35 USC § 119 from U.S. Provisional Application No. 63/334,928, entitled “MECHANISMS FOR GNB TO GNB INTERFERENCE MITIGATION FOR DYNAMIC TDD SYSTEM”, filed on Apr. 26, 2022, the subject matter of which is incorporated herein by reference. This application also claims priority under 35 USC § 119 from U.S. Provisional Application No. 63/347,906, entitled “MECHANISMS FOR GNB TO GNB INTERFERENCE MITIGATION FOR DYNAMIC TDD SYSTEM”, filed on Jun. 1, 2022, the subject matter of which is incorporated herein by reference.

### TECHNICAL FIELD

Embodiments herein relate to wireless communications, and more particularly, to a measurement and mitigation of cross-link interference.

### BACKGROUND

Mobile communication has evolved significantly from early voice systems to today's highly sophisticated integrated communication platform. The next generation wireless communication system, fifth generation technology for broadband cellular networks (5G), or new radio (NR) will provide access to information and sharing of data anywhere, anytime by various users and applications. NR is expected to be a unified network/system that target to meet vastly different and sometimes conflicting performance dimensions and services. Such diverse multi-dimensional requirements are driven by different services and applications. In general, NR will evolve based on 3GPP LTE-Advanced with additional potential new Radio Access Technologies (RATs) to enrich people lives with better, simple, and seamless wireless connectivity solutions. NR will enable everything connected by wireless and deliver fast, rich contents and services.

Time Division Duplex (TDD) is now widely used in commercial NR deployments, where the time domain resource is split between downlink and uplink symbols. In NR, TDD uplink/downlink (UL/DL) configuration can be semi-statically configured by next generation NodeB (gNB) via tdd-UL-DLConfigurationCommon or tdd-UL-DL-ConfigurationDedicated. In addition, dynamic TDD was introduced in the NR. In this case, gNB may dynamically allocate UL and DL resources in order to match the instantaneous traffic conditions for UL and DL transmissions, respectively, which can help in maximizing resource utilization and improving the user equipment (UE) throughput.

### BRIEF DESCRIPTION OF THE DRAWINGS

FIG. 1A depicts an embodiment of a system including base stations and user equipment interconnected via a communication network;

FIG. 1B depicts an embodiment of a system including base stations and user equipment interconnected via a communication network to illustrate cross-link interference such as the user equipment and base stations shown in FIG. 1A;

FIG. 2 depicts embodiments of a base station and user equipment, such as the base station and the user equipment illustrated in FIGS. 1A-1B;

FIG. 3 depicts an embodiment of communications between a user equipment and a base station including non-overlapping subband full duplex (SBFD) communications such as the user equipment and base stations shown in FIGS. 1A, 1B, and 2;

FIG. 4 depicts an embodiment of communications between a user equipment and two base stations for mitigation of cross-link interference, such as the user equipment and base stations shown in FIGS. 1A, 1B, and 2;

FIG. 5A depicts an embodiment of an aggressor gNB or base station that transmits a sounding frame or other frame for measurement by neighboring base stations to mitigate cross-link interference, such as the base stations shown in FIGS. 1A, 1B, and 2;

FIG. 5B depicts an embodiment of a victim gNB or base station that measures a sounding frame or other frame from an aggressor base station to mitigate cross-link interference, such as the base stations shown in FIGS. 1A, 1B, 2 and 5A;

FIG. 5C depicts another embodiment of a victim gNB or base station that measures a sounding frame or other frame from an aggressor base station to mitigate cross-link interference, such as the base stations shown in FIGS. 1A, 1B, 2 and 5A-5B;

FIGS. 6A-B depict flowcharts of embodiments to measure and mitigate cross-link interference FIGS. 6A-B such as the embodiments described in conjunction with FIGS. 1A-1B, 2, 3, 4, and 5A-5C;

FIGS. 7A-B depict flowcharts of alternative embodiments to measure and mitigate cross-link interference such as the embodiments described in conjunction with FIGS. 1A-1B, 2, 3, 4, and 5A-5C;

FIG. 8 depicts an embodiment of protocol entities in wireless communication devices such as the base station and user equipment shown in FIGS. 1A-1B and 2;

FIG. 9 depicts embodiments of the formats of physical layer data units (PDUs) that form via baseband circuitry and RF transceiver circuitry such as the baseband circuitry and the RF transceivers shown in FIG. 2;

FIGS. 10A-B depicts embodiments of communication circuitry such as the components and modules shown in the user equipment and base station shown in FIG. 2;

FIG. 11 depicts an embodiment of a storage medium described herein;

FIG. 12 depicts an embodiment of an architecture of a system of a network such as the communication networks in FIGS. 1A-1B;

FIG. 13 depicts an embodiment of a device such as a base station or user equipment shown in FIGS. 1A, 1B, and 2;

FIG. 14 depicts an embodiment of interfaces of baseband circuitry such as the baseband circuitry shown in FIG. 2; and

FIG. 15 depicts an embodiment of a block diagram of components to perform functionality described herein such as the functionality described in conjunction with FIGS. 1A-1B, 2-4, 5A-5C, 6A-6B, 7A-7B, 8-9, 10A-10B, and 11-14.

### DETAILED DESCRIPTION OF EMBODIMENTS

The following is a detailed description of embodiments depicted in the drawings. The detailed description covers all modifications, equivalents, and alternatives falling within the appended claims.

To improve the performance for uplink transmission in a dynamic time division duplex (TDD) system, simultaneous transmission and reception of downlink (DL) and uplink (UL) on the same frequency resources (subcarriers of a carrier bandwidth) may be considered. For example, dynamic TDD includes flexible symbols or slots that a base station may dynamically allocate or assign to downlink (DL) communications or uplink (UL) communications based on traffic load conditions while static TDD may include sets of symbols that remain allocated to either DL communications for UL communications.

Furthermore, dynamic TDD may include non-overlapping subband full duplex (SBFD or NO SBFD) symbols wherein the channel bandwidth of the communication may include one or more UL communications and one or more DL communications on different sets of subcarriers, also referred to as subbands or bandwidth parts (BWPs). For example, within a symbol, a base station such as a next generation NodeB, or gNodeB (gNB) can transmit DL in one subband and receive UL in another subband that are not overlapped during SBFD operations. The subband corresponds to a number of contiguous frequency resources within a carrier (e.g., Physical Resource Blocks (PRBs) on the Common Resource Block (CRB) grid). Communication resources, as discussed herein, refer to the frequency resources at a particular point in time within communications. For instance, reference to two base stations transmitting or receiving on the same communication resources, indicates concurrent communications within the same frequency resources. Dynamic

TDD as described herein may also include dynamic configuration for SBFD.

Without coordination between nearby or neighboring gNBs, certain types of cross link interference (CLI) may occur in dynamic TDD systems, especially when considering that two gNBs from different operators may concurrently transmit DL and UL communications within the same frequency band or bandwidth. For example, cross-link interference for a dynamic TDD system may occur between UL and DL communications in neighboring gNBs because of the different transmission directions (UL and DL) among neighboring gNBs at a given time on the same carrier frequency and within the same frequency bandwidths, when the DL communication of a first gNB is directed in the general direction of the receiver antennas of a second gNB. Note that CLI may also occur if the DL communication is omni-directional but base stations such as the gNB typically use beamforming to direct DL communications in the direction of the UE that is the intended recipient of the DL. If the UE is in the general direction of a receiver of a second gNB, a first gNB may transmit the DL generally towards the receiver of the second gNB.

Two types of CLI can be observed under dynamic TDD operation: user equipment (UE)-to-UE interference and gNB-to-gNB interference. For UE-to-UE interference, CLI arises when a UL transmission of a first UE interferes with the DL transmission from a gNB in a serving cell to a neighboring UE. The “serving” cell, base station, or gNB generally refers to the base station of a cell of a cellular system that is transmitting DL communications to a UE. Furthermore, for gNB-to-gNB interference, gNB-to-gNB CLI is generated when a DL transmission of a neighboring gNB interferes with reception of the UL transmission of a UE by a serving cell gNB.

At the base stations, the CLI may manifest as communication errors such as a high error rate, dropped packets, and/or repeated transmissions of the same packets from a UE to the base station. Without coordination and synchronization between the base stations, dynamic TDD may allow UL and DL transmissions to overlap. Thus, a first base station may transmit a DL generally in the direction of a second base station while the second base station is attempting to receive a transmission from a UE on the same carrier, causing adjacent channel CLI or co-channel CLI from the first base stations transmission into the reception by the second base station of the UE's transmission.

During SBFD operation, dynamic TDD DL transmissions from a first base station may cause CLI at the second base station not only at UL transmissions received by the second base station within the same (or overlapping) subband of the carrier (co-channel CLI) but also at adjacent subbands to the UL transmissions to the second base station (adjacent-channel CLI). For instance, SBFD operation may or may not include guard bands (unused sets of subcarriers) between UL and DL communications within the same symbol or slot and neighboring base stations may have different configurations of SBFD symbols, particularly if the base stations have different operators.

During a SBFD communication, a subband for UL may reside between subbands for DL. While guard bands, if employed, may mitigate interference between the UL and DL subbands, the DL signals from an aggressor base station may cause inter-subband CLI on the UL subband of a nearby (or victim) base station. In such situations, the victim base station may recognize the impacted link based on communication errors, dropped communications, and/or the like, associated with UL communications from the UE.

Embodiments may define methods and arrangements to measure cross link interference (CLI) between dynamic TDD communications to mitigate the CLI and/or to facilitate mitigation measures. For instance, if the victim base station repeatedly detects errors in UL communication from a UE, the victim base station may trigger periodic, semi-persistent, or aperiodic measurements of CLI of a DL communication from an aggressor base station to determine the parameters of the CLI such as the CLI received signal strength indicator (CLI-RSSI), CLI reference signal received power (CLI-RSRP), or the CLI signal-to-noise and interference ratio (SNIR). In some embodiments, the victim base station may measure the CLI from the aggressor base station while the aggressor base station transmits DL communications to UEs associated with the aggressor base station. In some embodiments, the victim base station may communicate with the aggressor base station via, e.g., backhaul signaling, to trigger transmission of one-time, periodic, semi-persistent, or aperiodic reference signals from the aggressor base station to UEs associated with the aggressor base station to facilitate measurement of the CLI-RSSI, CLI-RSRP, and/or CLI-SNIR. In some embodiments, the reference signals may comprise a channel state information reference signal (CSI-RS) or a sounding reference signal (SRS).

In preparation of DL transmission of a CLI-RS, the first base station may transmit or share, via, e.g., backhaul signaling, a CLI-RS resource and measurement configuration. The CLI-RS resource and measurement configuration may include information about the type of measurement such as CLI RSSI or CLI-RS, the type of reference signal such as a CSI-RS or a SRS, parameters to identify the location of the CLI-RS in a DL transmission, the type of measurement report such as a layer 1 (L1) or layer 3 (L3) CLI-RSRP or a CLI-RSSI measurement report, and/or the like. Note that, in some embodiments, one or more of or all these parameters may be set as default settings. In some embodiments, once one or more parameters of the CLI-RS resource and measurement configuration is shared with neighboring base stations, the one or more parameters may be assumed to remain the same unless alternative parameter values are transmitted from the first base station to the neighboring base stations and/or from one of the neighboring base stations to other of the neighboring base stations.

In some embodiments, the first base station may transmit or share, via e.g., backhaul signaling, in the CLI-RS resource and measurement configuration, a number of repetitions with which the first base station will transmit the CLI-RS in the same direction (or sector) and/or transmit the CLI-RS during a sweep through multiple directions (or sectors). By repeating the same CLI-RS in the same sector, other base stations that may be measuring the CLI-RS may sweep through multiple receive sectors to determine multiple measurements for the CLI-RS in multiple directions and/or antenna configurations. By transmitting the CLI-RS repeatedly while sweeping through multiple different sectors, the other base stations may perform measurement of the CLI for multiple directions of transmissions from the first base station. Note that every base station can be a victim in some circumstances and an aggressor in other circumstances so sweeping through sectors may facilitate generation of vectors of CLI and/or a matrix of CLI by each of the neighboring base stations for the neighboring base stations. Such base stations may store the vectors and/or the matrix in memory of the respective base stations.

In some embodiments, an aggressor base station or a victim base station may transmit or share a muting pattern to mute one or more neighboring base stations during measurement of the CLI-RS. For instance, the aggressor base station or the victim base station may transmit the zero-power (ZP) CLI-RS transmissions to neighboring base stations to instruct or encourage the other base stations to mute the channel during the measurements. If multiple base stations repeat this process, possibly triggered by a victim base station, the neighboring base stations in each case may measure the CLI and report the measurements to the neighboring base stations so measurements may be taken to mitigate CLI.

In some embodiments, the victim base station may transmit a muting pattern or a configuration for a measurement that the victim base station may perform to implicitly instruct the other base stations not to transmit during the measurement.

Based on the measurements of the CLI-RSSI, the CLI-RSRP, or the CLI-SNIR, the victim base station and/or the aggressor base station may take mitigation measures to mitigate the CLI. For instance, the victim base station may assign UEs with weaker UL signals to different UL resources such as PRBs that do not have high enough CLI to cause interference or may not assign a UE to an UL during SBFDs. In some embodiments, the victim base station may request that the aggressor base station reduce power of DL signals during flexible symbols or during the SBFDs, in certain directions on certain communication resources, and/or the like.

Embodiments may define CLI measurement for a Node B's such as the evolved Node B (eNB) and the gNB for Radio Access Networks (RANs) such as RANI. RAN may be shorthand for E-UTRAN (Evolved Universal Terrestrial Radio Access Network) and the numbers such as 1 and 2 may represent the release numbers for the 3rd Generation Partnership Project (3GPP) E-UTRAN specifications. The NR may be co-existent with 3GPP Long Term Evolution (LTE) radios and may include beamforming for high frequencies such as frequencies above 6 gigahertz (GHz).

For illustration, CLI measurement and reporting may involve:
1. Configuration, by a first gNB, of a CLI-RS resource and measurement configuration via backhaul signaling with one or more neighboring gNBs.
2. Transmission, by the first gNB, of the CLI-RS in accordance with the CLI-RS resource and measurement configuration.
3. Measurement, by the one or more neighboring gNBs, of the CLI-RS in accordance with the CLI-RS resource and measurement configuration.
4. Transmission, by the one or more neighboring gNBs, of CLI-RS measurement reports to the first gNB via backhaul signaling.

In some embodiments, the CLI measurement and reporting configuration may include one or more parameters such as reference subcarrier spacing and cyclic prefix (CP) length; Point A that serves as a common reference point for resource block grid (or communication resources); channel bandwidth; time and frequency resource for the transmission of CLI-RS, CLI-RSSI, and/or CLI-SNIR measurement; a bandwidth part (BWP) for the transmission of CLI-RS; a system frame number of the serving cell (base station transmitting the CLI-RS); transmit configuration indicator (TCI) information for the corresponding CLI-RS transmission; and/or the like.

In some embodiments, a base station may exchange information for the configuration of SBFD. The base station may share a configuration of SBFD with nearby base stations including configuration of one or more of an intended DL and/or UL subbands within the SBFD symbols that may include at least the identification of frequency resources that may be used for UL reception at the base station; overall frequency resources including both UL and DL that may be identified via a signaling similar to indication of location and bandwidth (BW) configuration of a BWP; one or more guard bands and their locations in frequency, if any, within the SBFD symbols; time domain locations for SBFD symbols; and/or the like.

For RANs, the base station may execute code and protocols for E-UTRA, an air interface for base stations and interaction with other devices in the E-UTRAN such as UE. The E-UTRA may include the radio resource management (RRM) in a radio resource control (RRC) layer.

Various embodiments may be designed to address different technical problems associated with cross-link interference such as measuring CLI, communicating with neighboring base stations, transmitting or sharing a CLI resource and measurement report configuration, determining a CLI-RS for measurement, determining a level of measurement, determining parameters associated with measurement, determining a communication configuration for measurement, synching a SBFD communication for measurement, muting neighboring base stations during measurement, determining a configuration for a measurement report, sharing or transmitting a report of measurement, determining a direction of transmission from an aggressor base station causing CLI, and/or the like.

Different technical problems such as those discussed above may be addressed by one or more different embodiments. Embodiments may address one or more of these problems associated with cross-link interference. For instance, some embodiments that address problems associated with cross-link interference may do so by one or more different technical means, such as, triggering measurement of CLI, triggering transmission of a CLI-RS by an aggressor base station for measurement; determining a muting pattern during measurement; sharing a muting pattern for measurement by a victim or aggressor base station; determining parameters of a CLI-RS resource and measurement configuration; synching communications between an aggressor and victim base station for performing a CLI-RS for measurement; determining a level of measurement for CLI; identifying a point A as a reference point for communication resources; repeatedly transmitting a CLI-RS for measurement and reporting; repeatedly measuring a CLI-RS for a CLI-RS measurement report; sharing a CLI-RS measurement report; performing measurement of a CLI-RS for SBFD communication; and/or the like.

Several embodiments comprise systems with multiple processor cores such as central servers, access points, and/or stations (STAs) such as modems, routers, switches, servers, workstations, netbooks, mobile devices (Laptop, Smart Phone, Tablet, and the like), sensors, meters, controls, instruments, monitors, home or office appliances, Internet of Things (IoT) gear (watches, glasses, headphones, cameras, and the like), and the like. Some embodiments may provide, e.g., indoor and/or outdoor “smart” grid and sensor services. In various embodiments, these devices relate to specific applications such as healthcare, home, commercial office and retail, security, and industrial automation and monitoring applications, as well as vehicle applications (automobiles, self-driving vehicles, airplanes, drones, and the like), and the like.

The techniques disclosed herein may involve transmission of data over one or more wireless connections using one or more wireless mobile broadband technologies. For example, various embodiments may involve transmissions over one or more wireless connections according to one or more 3rd Generation Partnership Project (3GPP), 3GPP Long Term Evolution (LTE), 3GPP LTE-Advanced (LTE-A), 4G LTE, and/or 5G New Radio (NR), technologies and/or standards, including their revisions, progeny and variants. Various embodiments may additionally or alternatively involve transmissions according to one or more Global System for Mobile Communications (GSM)/Enhanced Data Rates for GSM Evolution (EDGE), Universal Mobile Telecommunications System (UMTS)/High Speed Packet Access (HSPA), and/or GSM with General Packet Radio Service (GPRS) system (GSM/GPRS) technologies and/or standards, including their revisions, progeny and variants.

Examples of wireless mobile broadband technologies and/or standards may also include, without limitation, any of the Institute of Electrical and Electronics Engineers (IEEE) 802.16 wireless broadband standards such as IEEE 802.16m and/or 802.16p, International Mobile Telecommunications Advanced (IMT-ADV), Worldwide Interoperability for Microwave Access (WiMAX) and/or WiMAX II, Code Division Multiple Access (CDMA) 2000 (e.g., CDMA2000 1×RTT, CDMA2000 EV-DO, CDMA EV-DV, and so forth), High Performance Radio Metropolitan Area Network (HIPERMAN), Wireless Broadband (WiBro), High Speed Downlink Packet Access (HSDPA), High Speed Orthogonal Frequency-Division Multiplexing (OFDM) Packet Access (HSOPA), High-Speed Uplink Packet Access (HSUPA) technologies and/or standards, including their revisions, progeny and variants.

Some embodiments may additionally perform wireless communications according to other wireless communications technologies and/or standards. Examples of other wireless communications technologies and/or standards that may be used in various embodiments may include, without limitation, other IEEE wireless communication standards such as the IEEE 802.11-2020, IEEE 802.11ax-2021, IEEE 802.11ay-2021, IEEE 802.11ba-2021, and/or other specifications and standards, such as specifications developed by the Wi-Fi Alliance (WFA) Neighbor Awareness Networking (NAN) Task Group, machine-type communications (MTC) standards such as those embodied in 3GPP Technical Report (TR) 23.887, 3GPP Technical Specification (TS) 22.368, 3GPP TS 23.682, 3GPP TS 36.133, 3GPP TS 36.306, 3GPP TS 36.321, 3GPP TS.331, 3GPP TS 38.133, 3GPP TS 38.306, 3GPP TS 38.321, 38.214, and/or 3GPP TS 38.331, and/or near-field communication (NFC) standards such as standards developed by the NFC Forum, including any revisions, progeny, and/or variants of any of the above. The embodiments are not limited to these examples.

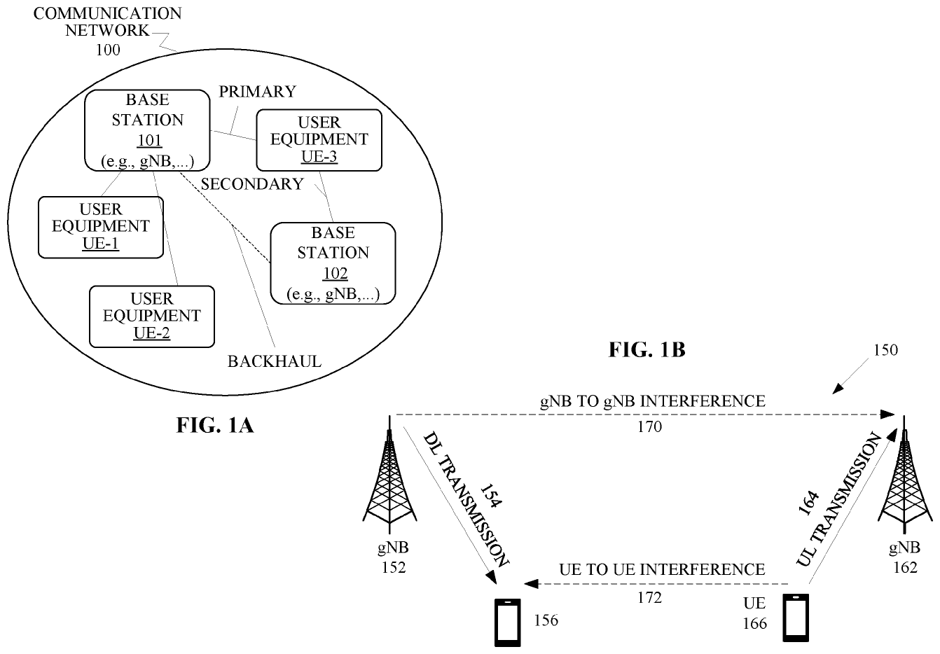

FIG. 1A illustrates a communication network 100 for cross link interference measurement and mitigation. The communication network 100 is an Orthogonal Frequency Division Multiplex (OFDM) network comprising a primary base station 101, a first user equipment UE-1, a second user equipment UE-2, a third user equipment UE-3, and a secondary base station 102. In a 3GPP system based on an Orthogonal Frequency Division Multiple Access (OFDMA) downlink, the radio resource is partitioned into subframes in time domain and each subframe comprises of two slots. Each OFDMA symbol further consists of a count of OFDMA subcarriers in frequency domain depending on the system (or carrier) bandwidth. The basic unit of the resource grid is called Resource Element (RE), which spans an OFDMA subcarrier over one OFDMA symbol. Resource blocks (RBs) comprise a group of REs, where each RB may comprise, e.g., 12 consecutive subcarriers in one slot.

Several physical downlink channels and reference signals use a set of resource elements carrying information originating from higher layers of code. For downlink channels, the Physical Downlink Shared Channel (PDSCH) is the main data-bearing downlink channel, while the Physical Downlink Control Channel (PDCCH) may carry downlink control information (DCI). The control information may include scheduling decision, information related to reference signal information, rules forming the corresponding transport block (TB) to be carried by PDSCH, and power control command. UEs may use cell-specific reference signals (CRS) for the demodulation of control/data channels in non-precoded or codebook-based precoded transmission modes, radio link monitoring and measurements of channel state information (CSI) feedback. UEs may use UE-specific reference signals (DM-RS) for the demodulation of control/data channels in non-codebook-based precoded transmission modes.

The communication network 100 may comprise a cell such as a micro-cell or a macro-cell and the base station 101 may provide wireless service to UEs within the cell. The base station 102 may provide wireless service to UEs within another cell located adjacent to or overlapping the cell. In other embodiments, the communication network 100 may comprise a macro-cell and the base station 102 may operate a smaller cell within the macro-cell such as a micro-cell or a picocell. Other examples of a small cell may include, without limitation, a micro-cell, a femto-cell, or another type of smaller-sized cell.

In various embodiments, the base station 101 and the base station 102 may communicate over a backhaul. In some embodiments, the backhaul may comprise a wired backhaul. In various other embodiments, backhaul may comprise a wireless backhaul. In some embodiments, the backhaul may comprise an Xn interface or a F1 interface, which are interfaces defined between two RAN nodes or base stations such as the backhaul between the base station 101 and the base station 102. The Xn interface is an interface for gNBs and the F1 interface is an interface for gNB-Distributed units (DUs) if the architecture of the communication network 100 is a central unit/distributed unit (CU/DU) architecture.

The base stations 101 and 102 may communicate protocol data units (PDUs) via the backhaul. As an example, for the Xn interface, the base station 101 may transmit or share control plane PDUs via an Xn-C interface and may transmit or share data PDUs via a Xn-U interface. For the F1interface, the base station 101 may transmit or share control plane PDUs via an F1-C interface and may transmit or share data PDUs via a F1-U interface. Note that discussions herein about signaling, sharing, receiving, or transmitting via a Xn interface may refer to signaling, sharing, receiving, or transmitting via the Xn-C interface, the Xn-U interface, or a combination thereof. Similarly, discussions herein about signaling, sharing, receiving, or transmitting via a F1 interface may refer to signaling, sharing, receiving, or transmitting via the F1-C interface, the F1-U interface, or a combination thereof.

In some embodiments, the base stations 101 and 102 may comprise CLI logic circuitry to coordinate, via the backhaul or by other communication methods, to measure and mitigate cross link interference (CLI). CLI may occur when a base station such as the base station 101 transmits a DL communication to a UE such as UE-3 in the general direction of the base station 102 while the base station 102 is receiving an UL communication from another UE on the same communication resources of carrier frequency. The DL transmission from the base station 101 may cause the receiver of the base station 102 to detect energy from the DL while attempting to receive a UL communication from the other UE. The energy at the receiver of the base station 102 from the DL transmission may be strong enough to cause errors in the capture of energy of the UL communication, which could potentially cause the receiver of the base station 102 to fail to capture portions of or all the UL communication or, in some circumstances, fail to detect the UL communication.

In some embodiments, the CLI logic circuitry of the base station 102 may determine the existence of the CLI and determine to mitigate the CLI if the CLI exceeds a threshold such an energy threshold, a noise threshold, or an error threshold, causing errors in the process of capturing an UL transmission. In some embodiments discussed herein, the base station experiencing the CLI is referred to as a victim base station and the base station that is causing the CLI is referred to as an aggressor base station. Note that every base station can be an aggressor, a victim, or both an aggressor and a victim, depending on the circumstances.

In some embodiments, the CLI logic circuitry of the victim base station such as the base station 102 in the example above, may determine to measure the CLI. In some circumstances, if the CLI does not exceed a threshold signal strength, such as a received signal strength indicator (RSSI), and the CLI is periodic, errors in communication of the UL from a UE may be related to the signal strength of the UL communication from the UE and the communication resources (or PRBs) allocated to the UE for UL. If UL communication from a particular UE or a group of UEs associated with the victim base station is relatively weak, the CLI logic circuitry of the victim base station may move the relatively weak UL communications to communication resources that do not experience the CLI from the aggressor base station (or aggressor base stations). In such circumstances, the CLI logic circuitry of the victim base station may assign the PRBs subject to the CLI to UEs that have stronger signal strengths or assign the PRBs subject to the CLI to DL communications.

In some embodiments, the CLI logic circuitry of the victim base station may determine to communicate with the aggressor base station to address the CLI. In such embodiments, the CLI logic circuitry of the victim base station may transmit or share a PDU including a source address, a destination address, a source tunnel endpoint identifier (TEID), a destination TEID, and/or the like, and an indication to trigger or request that the aggressor base station coordinate a measurement of the CLI for mitigation.

In response to receipt of the PDU from the victim base station, the CLI logic circuitry of the aggressor base station may generate a CLI resource and measurement configuration and send the CLI resource and measurement configuration in a PDU to the victim base station and possibly other neighboring base stations via the backhaul. The CLI resource and measurement configuration may comprise an identification for or definition of a reference signal for measurement of CLI (CLI-RS), an identification of a communication resource for the CLI-RS and/or an identification of the communication resource within which to measure the CLI-RS, and a definition for a CLI-RS measurement report. In some embodiments, the CLI resource and measurement configuration may comprise one or more parameters of the CLI-RS measurement and reporting that have not already been sent to the neighboring base stations, that are not already known by the neighboring base stations, or that have changed from the already known or previously sent one or more parameters. For instance, the definition for a CLI-RS measurement report may be specified by a specification or set as a default setting and may not be part of the CLI resource and measurement configuration.

The identification or definition for the CLI-RS may include one or more parameters to define the CLI-RS as is a channel state information reference signal (CSI-RS) or a sounding reference signal (SRS). In some embodiments, the CLI-RS resource and measurement configuration may also identify a periodic, a semi-persistent, or an aperiodic CLI-RS for generation of the CLI-RS measurement report. In other embodiments, the CLI logic circuitry of the aggressor base station may indicate resources within which to measure the CLI from one or more DL signals that the aggressor base station may transmit to a UE for generation of the CLI measurement report.

In some embodiments, the identification of the communication resource may comprise the one or more parameters including a reference subcarrier spacing and a cyclic prefix (CP) length, a point A as a common reference point for the communication resource, a channel bandwidth, a time and frequency resource for measurement, a bandwidth part (BWP) for the transmission of the CLI-RS, a system frame number (SFN) for the CLI-RS, a transmit configuration indicator (TCI) information for the CLI-RS, or a combination thereof. The point A may be a common reference point from which the victim base station and possibly other base stations may determine the location of the communication resources for measurement of the CLI-RS.

The channel bandwidth may comprise the bandwidth of the channel of the CLI-RS DL transmission. The time and frequency resource for the transmission of CLI-RS or for a CLI-RSSI measurement of the CLI-RS may include a starting physical resource block (PRB). The starting PRB may be indicated with respect to a BWP configuration or based on a common resource block (CRB) grid, a length of PRBs, a periodicity and offset for the PRBs, a symbol position in a slot, and/or the like. The symbol position in the slot may comprise, e.g., starting symbols as well as the number of symbols. The slot may be the communication resources for the transmission of CLI-RS or for a CLI-RSSI measurement of the CLI-RS. The BWP may be the part of the channel bandwidth within which the CLI-RS is mapped. In some embodiments, for example, the BWP may not be included if the time and frequency resource for the transmission of CLI-RS or for a CLI-RSSI measurement of the CLI-RS is directly mapped to the CRB grid.

The SFN may be included to coordinate the indexing in the time domain of the slots, subframes, and system frames. The 5G system may have system (or radio) frames that are 10 milliseconds (ms) long that are divided into 10 subframes, each subframe having a 1 ms duration. Each subframe may have 2 micro slots and each slot may have, e.g., 14 OFDM symbols. The slot length may vary based on the subcarrier spacing and the number of slots per subframe. For example, a slot may have a 1 ms duration for 15 kilohertz (KHz) subcarrier spacing, a 500 microseconds (μs) duration for 30 KHz subcarrier spacing, and the like. The subcarrier spacing of 15 KHz may occupy 1 slot per subframe, subcarrier spacing of 30 KHz may occupy 2 slots per subframe and the like. Furthermore, each slot may occupy either 14 OFDM symbols for a normal CP or 12 OFDM symbols for an extended CP.

The TCI may provide spatial or direction information for the CLI-RS transmission. For instance, transmissions between the base stations such as base station 101 and base station 102 may be directional transmissions rather that omni-directional transmissions. Directional transmissions are accomplished through transmission of waveforms with constructive and destructive interference that focus the transmissions in a particular direction, which would be a direction towards the UE for a DL transmission. In some embodiments, a base station may divide 360 degrees of directions into sectors such as eight sectors of 45 degrees per sector and adjust the antennas of the transmitter for transmission towards one sector or adjust the antennas of the receiver for reception from one sector. The number of sectors may vary. Directional transmission and reception may improve power consumption for transmission in the sector while decreasing interference with neighbor devices. Directional reception of communications may increase sensitivity for reception by the receiver for the sector and decrease or filter interference received from other sectors.

In some embodiments, if the victim base station identifies CLI in a SBFD communication, the aggressor base station may generate a CLI resource and measurement configuration for SBFD operation. The CLI resource and measurement configuration for SBFD operation may include the one or more parameters of the CLI resource and measurement configuration above but identify transmission of the CLI-RS for one or more DL bands of the SBFD or a measurement configuration for the victim base station in one or more UL bands of the SBFD. In some embodiments, the aggressor base station may optionally synchronize the PRBs transmitted from the aggressor base station with the PRBs of the victim base station for CLI-RS measurement in the SBFD operation.

The CLI logic circuitry of the victim base station and other base stations that receive the CLI resource and measurement configuration from the aggressor base station may receive the CLI resource and measurement configuration via the backhaul or other communication channel. The CLI logic circuitry of the victim base station and other base stations may parse the PDU with the CLI resource and measurement configuration, to determine the CLI resource and measurement configuration, and may parse the CLI resource and measurement configuration to determine each of the one or more parameters included in the CLI resource and measurement configuration.

After parsing the CLI resource and measurement configuration to determine the one or more parameters, the victim base station and other base stations may prepare to measure the CLI-RS in accordance with the CLI resource and measurement configuration.

In some embodiments, the victim base station or the aggressor base station may transmit or share a muting pattern via the backhaul or another communication medium with other neighboring base stations. For instance, the victim base station may identify the communication resources on which the victim base station will measure the CLI-RS to imply or request that the other neighboring base stations do not DL in the direction of the victim base station on the communication resources during the measurement(s).

As another example, the aggressor base station may transmit or share a muting pattern to request that neighboring base stations do not DL in the direction of the victim base station on the communication resources during the measurement(s). The muting pattern may include a zero power (ZP) CLI-RS DL transmission from the neighboring base stations in the direction of the victim base station on the communication resources during the measurement(s). The ZP CLI-RS may be a DL CLI-RS that is transmitted with a zero-power transmission. In other words, the ZP CLI-RS is allocated for a DL transmission but is not transmitted because no transmission power is applied to the transmission, which signals to the neighboring base stations not to transmit on the communication resources during the measurement(s).

After the victim base station and optionally the neighboring stations receive the CLI resource and measurement configuration and optionally a muting pattern from the victim or aggressor base station, the aggressor base station may transmit the CLI-RS on the communication resources indicated in the CLI resource and measurement configuration. If the communication resources are for SBFD operation, the CLI resource and measurement configuration may identify one or more DL communication resources for transmission of the CLI-RS and/or one or more UL communication resources for the victim base station to measure the CLI-RS.

After measuring the CLI-RS, the victim base station and optionally the neighboring stations may generate a CLI-RS measurement report as described in the CLI-RS resource and measurement configuration. The CLI-RS resource and measurement configuration may identify CLI-RS measurement report as a CLI Reference Signal Received Power (CLI-RSRP) or a CLI Received Signal Strength Indicator (CLI-RSSI) and may include a definition for the CLI-RS measurement report to comprise a L1 CLI-RS measurement report or a L3 CLI-RS measurement report. The L1 CLI-RS measurement report may include a single measurement of the CLI Reference Signal Received Power (CLI-RSRP) or the CLI Received Signal Strength Indicator (CLI-RSSI) or may include an average (or other combination) of two or more measurements of periodic, semi-persistent, or aperiodic CLI-RS transmissions by the aggressor base station for generation of the L1 CLI-RS measurement report. The L3 CLI-RS measurement report may include an average (or other combination) of more than three measurements of periodic, semi-persistent, or aperiodic CLI-RS transmissions by the aggressor base station for generation of the L3 CLI-RS measurement report. In some embodiments, the L1 and/or L3 CLI-RS measurement reports may comprise an algorithm for determining an average, a mean, or other combination of multiple measurements.

After the CLI logic circuitry of the victim base station and optionally the neighboring stations may generate CLI-RS measurement reports, the CLI logic circuitry of the victim base station and optionally the neighboring stations may transmit or share the CLI-RS measurement reports with the aggressor base station via the backhaul or other communication channel. In some embodiments, the neighboring stations may share the CLI-RS measurement reports with the victim base station and, in some embodiments, the victim base station may share the CLI-RS measurement reports with the neighboring base stations. In some embodiments, the victim base station may generate multiple CLI-RS measurement reports such as one per UL in SBFD operation and share the multiple CLI-RS measurement reports with the aggressor and neighboring base stations. In some embodiments, the victim base station may compile measurements for multiple CLI-RS measurement reports and share a compilation of the CLI-RS measurement reports as a single CLI-RS measurement report with the aggressor and neighboring base stations.

Once the aggressor and victim base stations have the one or more CLI-RS measurement reports, the aggressor and/or the victim base station may mitigate the CLI via one or more mitigation measures such as moving one or more UEs to other communication resources, reducing a transmission power by the aggressor base station for the communication resources subject to the CLI, changing the sector of the DL transmission by the aggressor base station during the communication resources subject to the CLI, and/or the like.

FIG. 1B depicts an embodiment of a dynamic TDD system 150 including base stations, gNBs 152 and 162, and user equipment 156 and 166 associated with gNBs 152 and 162 respectively, to illustrate cross-link interference 170 and 172, respectively such as the user equipment and base stations shown in FIG. 1A. In this example, because of the different transmission directions among neighboring gNB at a given time, two types of CLI can be observed under dynamic TDD operation: UE-to-UE interference 172 and gNB-to-gNB interference 170. For UE-to-UE interference 172, CLI arises when a UL transmission 164 from the UE 166 to a neighboring base station, the gNB 162, interferes with reception of the DL transmission 154 from a serving base station, the gNB 152, by the UE 156. Furthermore, for gNB-to-gNB interference 170, CLI is generated when a DL transmission 154 of a neighboring base station, the gNB 152, interferes with reception of the UL transmission 164 from the UE 166 by a serving base station, the gNB 164. In other words, the DL transmission 154 creates the gNB-to-gNB interference 170 (CLI) when energy from the DL transmission 154 is detected at the receiver antennas of the gNB 162 while the gNB 162 is attempting to receive the UL transmission 164. Similarly, the UL transmission 172 creates the UE-to-UE interference 172 (CLI) when energy from the UL transmission 164 is detected at the receiver antennas of the UE 156 while the UE 156 is attempting to receive the DL transmission 154. Note that in static TDD, this situation normally will not occur because the neighboring gNBs would DL at the same time (during the same communication resources) and would UL at the same time.

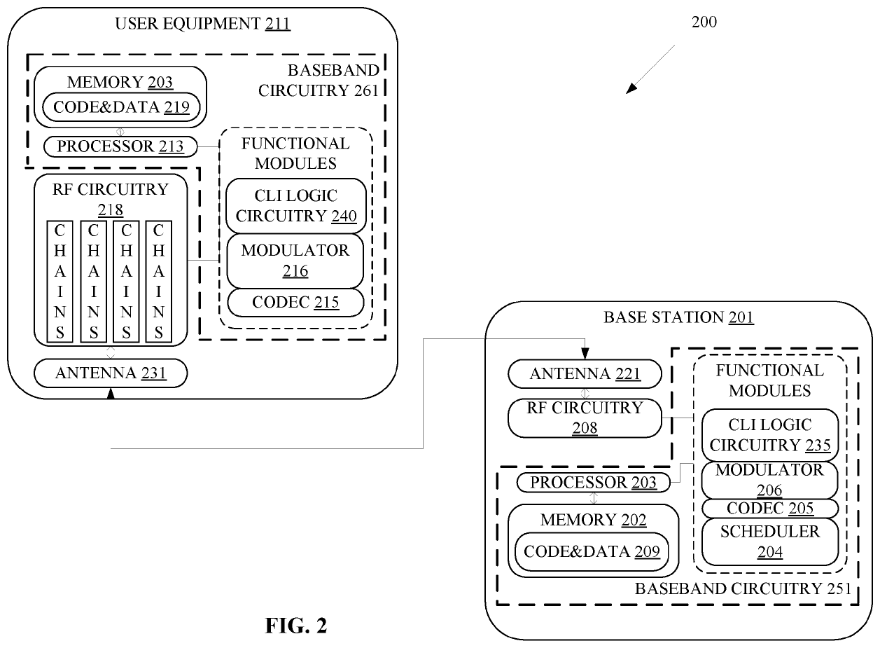

FIG. 2 is a simplified block diagram 200 of a base station 201 and a user equipment (UE) 211 that may carry out certain embodiments of the present invention in a communication network such as the base station 101, the UEs, and communication network 100 shown in FIG. 1. For the base station 201, the antenna 221 transmits and receives radio signals. The RF circuitry 208 coupled with the antenna 221, which is the physical layer of the base station 201, receives RF signals from the antenna 231, converts the signals to digital baseband signals, or uplink data, and sends them to the processor 203 of the baseband circuitry 251, also referred to as the processing circuitry or baseband processing circuitry, via an interface of the baseband circuitry 251. The RF circuitry 208 also converts received, digital baseband signals, or downlink data, from the processor 203 via an interface of the baseband circuitry 251, converts them to RF signals, and sends the RF signals out to antenna 221.

The processor 203 decodes and processes the digital baseband signals, or uplink data, and invokes different functional modules to perform features in the base station 201. The memory 202 stores program instructions or code and data 209 to control the operations of the base station 201. The processor 203 may also execute code such as RRC layer code from the code and data 209 to implement RRC layer functionality.

A similar configuration exists in UE 211 where the antenna 231 transmits and receives RF signals. The RF circuitry 218, coupled with the antenna, receives RF signals from the antenna 221, converts them to baseband signals, or downlink data, and sends them to processor 213 of the baseband circuitry 261 via an interface of the baseband circuitry 261. The RF circuitry 218 also converts digital baseband signals, or uplink data, from the processor 213, converts them to RF signals, and sends out the RF signals to the antenna 231.

The RF circuitry 218 illustrates multiple RF chains. While the RF circuitry 218 illustrates five RF chains, each UE may have a different number of RF chains and each of the RF chains in the illustration may represent multiple, time domain, receive (RX) chains and transmit (TX) chains. The RX chains and TX chains include circuitry that may operate on or modify the time domain signals transmitted through the time domain chains such as circuitry to insert guard intervals in the TX chains and circuitry to remove guard intervals in the RX chains. For instance, the RF circuitry 218 may include transmitter circuitry and receiver circuitry, which is often called transceiver circuitry. The transmitter circuitry may prepare digital data from the processor 213 for transmission through the antenna 231. In preparation for transmission, the transmitter may encode the data, and modulate the encoded data, and form the modulated, encoded data into Orthogonal Frequency Division Multiplex (OFDM) and/or Orthogonal Frequency Division Multiple Access (OFDMA) symbols. Thereafter, the transmitter may convert the symbols from the frequency domain into the time domain for input into the TX chains. The TX chains may include a chain per subcarrier of the bandwidth of the RF chain and may operate on the time domain signals in the TX chains to prepare them for transmission on the component subcarrier of the RF chain. For wide bandwidth communications, more than one of the RF chains may process the symbols representing the data from the baseband processor(s) simultaneously.

The processor 213 decodes and processes the digital baseband signals, or downlink data, and invokes different functional modules to perform features in the UE 211. The memory 212 stores program instructions or code and data 219 to control the operations of the UE 211. The processor 213 may also execute medium access control (MAC) layer code of the code and data 219 for the UE 211. For instance, the MAC layer code may execute on the processor 213 to cause UL communications to transmit to the base station 201 via one or more of the RF chains of the physical layer (PHY). The PHY is the RF circuitry 218 and associated logic such as some or all the functional modules.

The base station 201 and the UE 211 may include several functional modules and circuits to carry out some embodiments. The different functional modules may include circuits or circuitry that code, hardware, or any combination thereof, can configure and implement. Each functional module that can implement functionality as code and processing circuitry or as circuitry configured to perform functionality, may also be referred to as a functional block. For example, the processor 203 (e.g., via executing program code 209) is a functional block to configure and implement the circuitry of the functional modules to allow the base station 201 to schedule (via scheduler 204), encode or decode (via codec 205), modulate or demodulate (via modulator 206), and transmit data to or receive data from the UE 211 via the RF circuitry 208 and the antenna 221.

The processor 213 (e.g., via executing program code in the code and data 219) may be a functional block to configure and implement the circuitry of the functional modules to allow the UE 211 to receive or transmit, de-modulate or modulate (via de-modulator 216), and decode or encode (via codec 215) data accordingly via the RF circuitry 218 and the antenna 231.

Both the UE 211 and the base station 201 may include a functional module, CLI logic circuitry 240 and 235 respectively. The CLI logic circuitry 235 of the base station 201 may cause the processor to perform actions to measure and mitigate CLI related to dynamic TDD operations. For instance, the processor 203 may cause the base station 201 to transmit a CLI-RS resource and measurement configuration via backhaul signaling or other communications medium to a second base station. The CLI-RS resource and measurement configuration may comprise an identification of a communication resource within which to measure the CLI-RS and a definition for a CLI-RS measurement report. The communication resource within which to measure the CLI-RS may comprise communication resources on which the second base station can measure a CLI-RS or communication resources within which the base station 201 will transmit the CLI-RS. In some embodiments, the CLI-RS may comprise a CSI-RS or an SRS to transmit to the UE 213.

The definition for the CLI-RS measurement report may include a CLI Reference Signal Received Power (CLI-RSRP) or a CLI Received Signal Strength Indicator (CLI-RSSI) and may indicate that the measurement report may be a L1 CLI-RS measurement report or a L3 CLI-RS measurement report. For instance, the definition for the CLI-RS measurement report may indicate a L1 CLI-RSSI measurement report or a L1 CLI-RSRP measurement report. In further embodiments, the definition for the CLI-RS measurement report may indicate a L3 CLI-RSSI measurement report or a L3 CLI-RSRP measurement report.

After transmitting the CLI-RS resource and measurement configuration to the second base station, the CLI logic circuitry 235 of the base station 201 may cause the processor 203 to transmit one or more repetitions of the CLI-RS such as the CSI-RS or the SRS on the communication resources defined in the CLI-RS resource and measurement configuration, to transmit to the UE 213. The CLI logic circuitry of the UE 213 may ignore the CLI-RS or may transmit a report back to the base station 201 in response to receipt of the one or more repetitions of the CLI-RS.

The second base station may include CLI logic circuitry to cause the second base station to measure one or more repetitions of the CLI-RS in accordance with the CLI-RS resource and measurement configuration and generate a CLI-RS measurement report in accordance with the CLI-RS resource and measurement configuration such as a LI CLI-RSSI measurement report. The CLI logic circuitry of the second base station may cause the second base station to send the CLI-RS measurement report to the base station 201.

The CLI logic circuitry 235 of the base station 201 may receive the CLI-RS measurement report and determine mitigation measures, if any, to perform in response to the content of the CLI-RS measurement report. For instance, the CLI logic circuitry 235 of the base station 201 may determine to reduce transmission power of DL transmissions on the communication resources subject to the CLI indicated in the CLI-RS measurement report or determine not to DL communications during the communication resources subject to the CLI. In some embodiments, the CLI logic circuitry 235 of the base station 201 may determine not to DL communications during the communication resources subject to the CLI in the sector of the second base station as a mitigation measure to advantageously mitigate the base station to base station CLI.

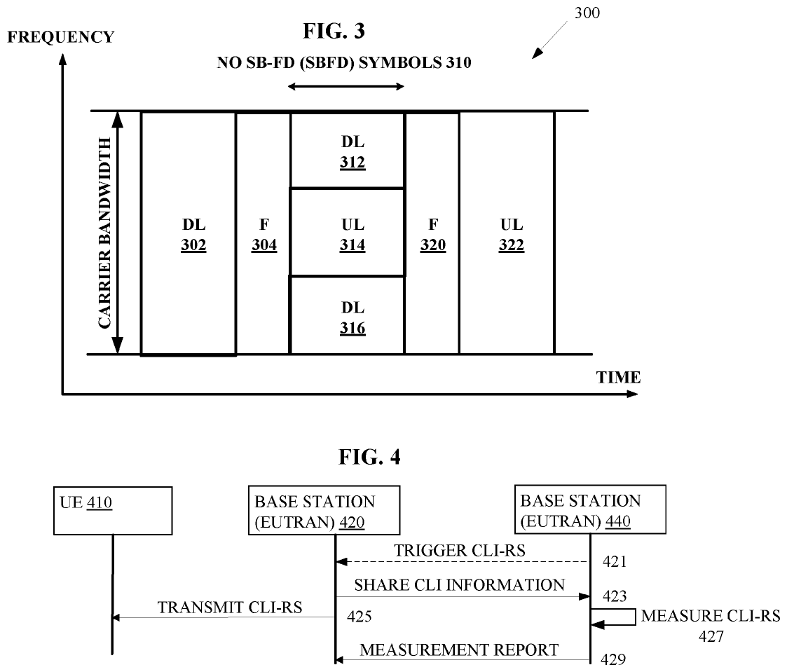

FIG. 3 depicts an embodiment of communication 300 between more than one UEs and a base station including non-overlapping subband full duplex (SBFD) communications 310 such as the user equipment and base stations shown in FIGS. 1A, 1B, and 2. FIG. 3 shows the communication 300 on a frequency bandwidth versus time graph and begins with a DL 302. DL 302 is the first communication that covers the entire channel bandwidth of a channel of the communication 300. The second communication is “F” 304, which are flexible symbols. Flexible symbols refer to symbols that have dynamic allocation under dynamic TDD, which means that the base station can dynamically choose to use the flexible symbols for a DL or for an UL to manage the UL/DL traffic conditions dynamically. If a first base station chooses to DL with the flexible symbols, F 304, and a second, neighboring base station chooses to UL with the flexible symbols corresponding to the same communication resources as the F 304, there is a possibility of CLI at the second, neighboring base station caused by the DL at F 304.

The SBFD includes three parallel communications as an example: DL 312, UL 314, and DL 316. SBFD communications may include multiple DL transmissions and multiple UL transmissions or one DL transmission and on UL transmission. For SBFD communications, overlapping communications by a neighboring base station may cause CLI if the overlapping communications are in different directions (UL and DL). In other words, SBFD operation can cause gNB-to-gNB inter-subband CLI and gNB-to-gNB intra-subband CLI. Overlapping DL and UL may occur, for instance, if communications are not accurately synced between a first base station and a second base station, the SBFD communication 310 may be allocated differently than SBFD communication on the same communication resources of the neighboring base station, or if the first base station implements SBFD operations and the second, neighboring base station does not implement SBFD operations. Furthermore, the DL 312 and the DL 316 may cause intra-band CLI in the UL of the SBFD of another base station that uses the same communication resources as UL 314.

gNB-to-gNB intra-subband CLI can be defined as the interference caused by transmission from one gNB (may be referred to as an “aggressor”) in a set of contiguous RBs in a carrier to reception of another gNB (referred to as a “victim”) in the same set of contiguous RBs in the same carrier concurrently.

Similarly, gNB-to-gNB inter-subband CLI can be defined as the interference caused by transmission from one gNB (may be referred to as an “aggressor”) in a first set of contiguous RBs in a carrier to reception of another gNB (referred to as a “victim”) in a second set of contiguous RBs in the same carrier concurrently, where the two contiguous RB sets are non-overlapping in frequency.

For SBFD operations, the CLI-RS resource and measurement configuration may include identification of multiple communication resources (RBs) for measurement and the aggressor base station may transmit a CLI-RS in each of the DL BWPs of the SBFD communication such as in DL 312 and DL 316. The victim base station may, in response to the CLI-RS resource and measurement configuration, perform one or more measurements of the CLI caused by the CLI-RS transmissions by the aggressor base station. For instance, the victim base station may perform a measurement for each UL BWP of the SBFD in the victim base station's SBFD in accordance with the CLI-RS resource and measurement configuration. In some embodiments, the victim base station may transmit separate measurement reports for each measurement in the SBFD and, in other embodiments, the victim base station may send a single CLI-RS measurement report comprising a compilation of all the measurements performed for the SBFD operation.

The F 320 may comprise another set of flexible symbols of communication resources across the entire channel bandwidth and the UL 322 may comprise a set of symbols designated for an UL transmission across the entire channel bandwidth.

FIG. 4 depicts an embodiment of a system illustrating communications between a UE 410 and two base stations, an aggressor base station 420 and a victim base station 440, for mitigation of cross-link interference, such as the user equipment and base stations shown in FIGS. 1A, 1B, and 2. CLI logic circuitry of the victim base station 440 may detect or suspect CLI from the aggressor base station 420 and may cause transmission, via a backhaul or other communication medium, of a PDU comprising a signal such as one or more bits to trigger a CLI-RS measurement coordinated by the aggressor base station 420. CLI logic circuitry of the aggressor base station 420 may share a PDU comprising CLI-RS resource and measurement configuration with the victim base station 440 via the backhaul or other communication medium. The CLI logic circuitry of the victim base station 440 may receive and parse the CLI-RS resource and measurement configuration to determine the parameters associated with measurement of the CLI-RS as well as one or more parameters to define a CLI-RS measurement report and may perform the measurement of the CLI-RS 427. Note that the CLI-RS resource and measurement configuration may define periodic, semi-persistent, or aperiodic transmissions of CLI-RS. In some embodiments, the definition of the CLI-RS measurement report (e.g., L1 or L3), defined in the CLI-RS resource and measurement configuration, may define the number of periodic, semi-persistent or aperiodic transmissions of CLI-RS to measure to generate a CLI-RS measurement report.

After performing the measurement of the CLI-RS 427, the CLI logic circuitry of the victim base station 440 may generate the CLI-RS measurement report and share the CLI-RS measurement report 429 with the aggressor base station via the backhaul or other communications medium. In some embodiments, the aggressor base station may share or transmit the CLI-RS resource and measurement configuration with the victim base station and one or more other neighboring base stations. The one or more of the neighboring base stations as well as the victim base station 440 may share or transmit the CLI-RS measurement reports with the aggressor base station 420. In some embodiments, the victim base station 440 may share the CLI-RS measurement report with all the neighboring base stations and the neighboring base stations may share the CLI-RS measurement reports with the victim base station 440 as well as with each other.

In some embodiments, the aggressor base station 420 may repeatedly transmit the CLI-RS in one sector about the aggressor base station 420 to allow the victim base station 440 and optionally the neighboring base stations to perform measurements in multiple sectors about the respective base stations. In other words, the parameters in the CLI-RS resource and measurement configuration may define multiple transmissions of the CLI-RS in the same sector and define measurements by the victim base station 440 in multiple sectors about the victim base station 440 and by the other neighboring base stations in multiple sectors about the respective neighboring base stations. Such measurements may advantageously determine the impact of the CLI on UL communications from multiple sectors of about the victim base station 440 and neighboring base stations.

In some embodiments, the aggressor base station 420 may repeatedly transmit the CLI-RS in a sweep through multiple sectors about the aggressor base station 420 to allow the victim base station 440 and optionally the neighboring base stations to perform measurements in a single sector. In other words, the parameters in the CLI-RS resource and measurement configuration may define multiple transmissions of the CLI-RS in the multiple sectors and define measurements by the victim base station 440 in a single sector so the victim base station 440 and the other neighboring base stations may determine the measurements for CLI for different sectors of transmission of the CLI-RS about the aggressor base station. Such measurements may advantageously determine the impact of the CLI on UL communications to the victim base station and to the neighboring base stations from multiple sectors of transmissions of DL communications about the aggressor base station 420.

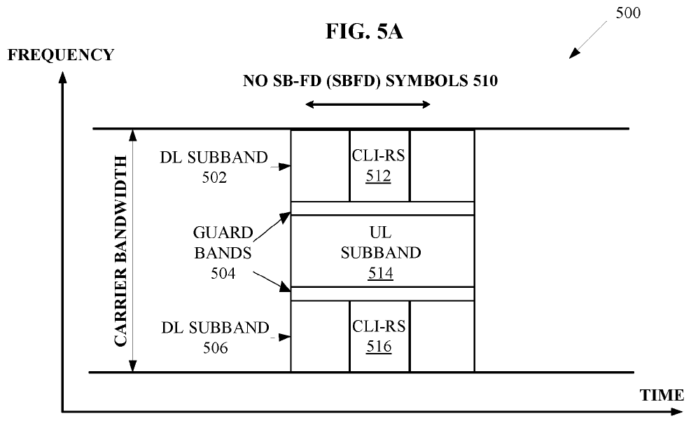

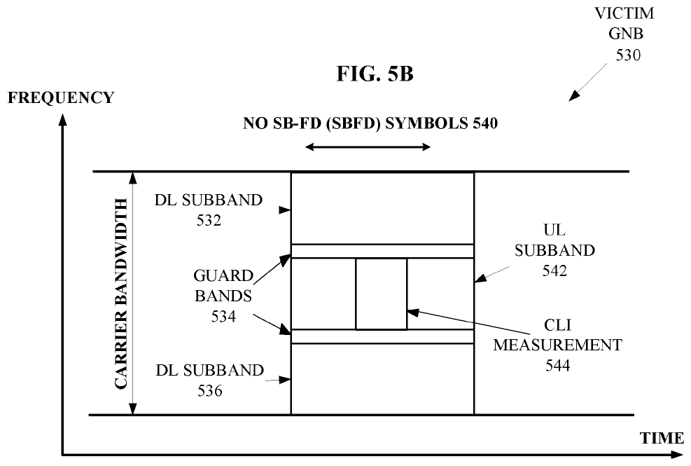

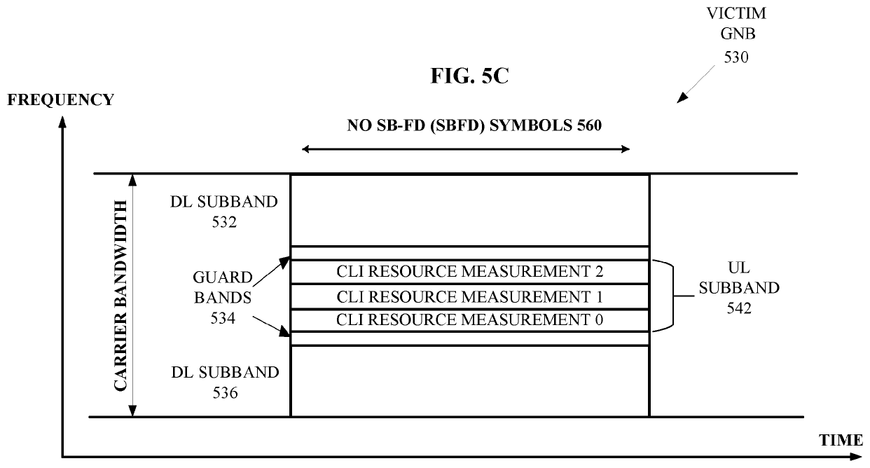

FIGS. 5A-C depict embodiments of measurements in SBFD operation for aggressor and victim base stations. In particular, FIG. 5A depicts an embodiment of an aggressor gNB 500 (or base station) that transmits a sounding frame or other frame for measurement by neighboring base stations including the victim base station to mitigate cross-link interference (CLI), such as the base stations shown in FIGS. 1A, 1B, and 2. FIG. 5A depicts a SBFD communication 510 on a graph of carrier bandwidth (frequency bandwidth) over time. The SBFD operation includes a DL subband 502, guard bands 504 about a UL subband 514, and a DL subband 506. The guard bands 504 may not have a substantial enough bandwidth to prevent inter-band CLI from the DL subbands 502 and 506 on a UL subband of a victim base station on the same communication resources (including carrier frequency and timing) as the UL subband 514. Note that the aggressor gNB 500 may have sufficient shielding and/or filtering to avoid inter-subband interference on UL subband 514.

In the present embodiment, CLI logic circuitry of the aggressor gNB 500 may cause transmission of a CLI-RS 512 in the upper DL subband 502 and a CLI-RS 516 in the lower DL subband 506 for measurement. Note that the aggressor gNB 500 may include information about the SBFD configuration for measurement in the CLI-RS resource and measurement configuration in the form of communication resources to be measured or in the form of communication resources within which the aggressor gNB 500 may transmit the CLI-RS 512 and CLI-RS 516. In some embodiments, the gNB may synchronize (sync or synch) the SBFD operations of the aggressor base station with the SBFD operations of the victim base station at least for the purposes of performing the measurements. In other embodiments, the victim base station may synchronize the SBFD operations of the victim base station with the SBFD operations of the aggressor base station at least for the purposes of performing the measurements.

FIG. 5B depicts an embodiment of a victim gNB 530 (or base station) that measures a sounding frame or other frame from an aggressor gNB (or base station) to mitigate cross-link interference (CLI), such as the base stations depicted in FIGS. 1A, 1B, 2 and 5A. FIG. 5B depicts a SBFD communication 510 on a graph of carrier bandwidth (frequency bandwidth) over time. The SBFD operation includes a DL subband 532, guard bands 534 about a UL subband 542, and a DL subband 536. The guard bands 534 may not have a substantial enough bandwidth to prevent inter-band CLI from the DL subbands 502 and 506 of the aggressor gNB 500 in FIG. 5A on a UL subband 542 of a victim gNB 530, which is on the same communication resources (including carrier frequency and timing) as the UL subband 514 of the aggressor gNB 500 in FIG. 5A.

The CLI measurement 544 may correspond to communication resources for measurement in the CLI-RS resource and measurement configuration received from the aggressor gNB 500 in FIG. 5A.

FIG. 5C depicts another embodiment of a victim gNB 530 that measures a sounding frame or other frame from an aggressor gNB 500 in FIG. 5A to mitigate cross-link interference, such as the base stations shown in FIGS. 1A, 1B, 2, and 5A-5B. In the present embodiment, the CLI resource and measurement configuration from the aggressor gNB 500 may define measurement of the entire set of PRBs (communication resources) in the UL subband 542 rather than measurement of a specific set of PRBs within the UL subband 542. Furthermore, the CLI resource and measurement configuration from the aggressor gNB 500 may define three subbands of the UL subband 542 for measurement of the entire set of PRBs (communication resources) in the UL subband 542 including a CLI resource measurement 2, a CLI resource measurement 1, and a CLI resource measurement 0. Note that the number of different measurements in the UL subband 542 may vary and the maximum may depend on the capabilities of measurement by the victim gNB 530. In other words, the CLI resource and measurement configuration from the aggressor gNB 500 may define three, four, five, six, seven, eight, or more subbands of the UL subband 542 for measurement of the communication resources in the UL subband 542. In other embodiments, the victim gNB 530 may determine to perform the CLI-RS measurements in multiple subbands of the UL subband 542 based on the capabilities of the victim gNB 530. In still other embodiments, the victim gNB 530 may negotiate, with the aggressor gNB 500, the number of subbands within the UL subband 542 to measure and share or transmit a CLI-RS measurement report based on the CLI-RS measurements.

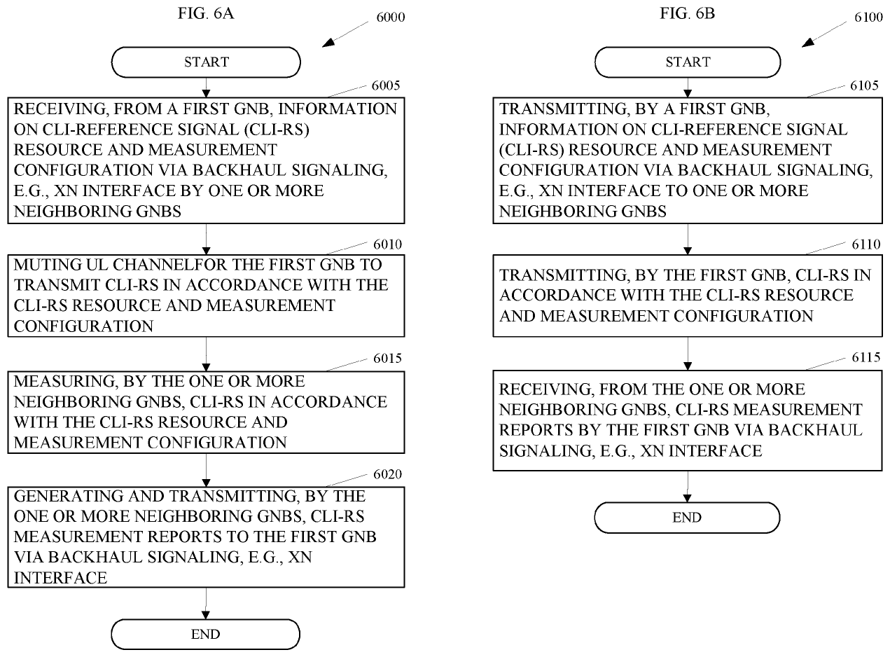

FIGS. 6A-B depict flowcharts of embodiments to measure and mitigate cross-link interference such as the embodiments described in conjunction with FIGS. 1A-1B, 2, 3, 4, and 5A-5C. FIG. 6A illustrates an embodiment of a flowchart 6000 to measure and mitigate cross-link interference. The flowchart 6000 begins with receiving, from a first gNB (or base station), information on CLI-RS resource and measurement configuration via backhaul signaling, e.g., Xn interface by one or more neighboring gNBs (element 6005). For example, CLI-logic circuitry of the first gNB may determine to mitigate the CLI autonomously (or self-triggering) or may receive an indication of CLI or a trigger to initiate a procedure to mitigate CLI from a second gNB. In some embodiments, the CLI logic circuitry of the first gNB may define the CLI-RS in the CLI-RS resource and measurement configuration as a periodic, a semi-persistent, or an aperiodic CLI-RS that can be triggered by the second gNB (or another neighboring gNB) or automatically transmitted the first gNB. In some embodiments, the first gNB in a serving cell transmits CLI-RS in accordance with the same DL transmission timing of the serving cell. In some embodiments, the first gNB transmits CLI-RS in accordance with the same DL transmission timing of a second gNB such as a victim gNB.

Furthermore, CLI-RS can be based on channel state information reference signal (CSI-RS) or a sounding reference signal (SRS). When CSI-RS is used for gNB-to-gNB CLI measurement and reporting, an existing CSI-RS resource and measurement configuration may be reused for the CLI-RS. In this case, either L1 or L3 CLI-RSRP or CLI-RSSI measurement report can be exchanged from the neighboring cell to the serving cell.

In some embodiments for SBFD with dynamic TDD operation, CLI logic circuitry of a first gNB may exchange information for the configuration of SBFD in the CSI-RS resource and measurement configuration. The configuration of SBFD may be shared with nearby gNBs and may include one or more of:
intended DL and/or UL subband configuration within the SBFD symbols, which may include the identification of frequency resources of the communication resources that may be used for UL reception at the first gNB,
overall communication resources including both UL and DL that may be identified via a signaling similar to indication of location and bandwidth (BW) configuration of a BWP. Note that the frequency resource may span one or more BWPs configured by the first gNB or its neighboring gNB to their served UEs respectively.
one or more guard bands and their locations in frequency resources, if any, within the SBFD symbols, and/or
time domain locations for SBFD symbols.

Note that a SBFD configuration may be assumed to be valid until a new configuration is received. The configuration of SBFD may be exchanged together with intended UL/DL configuration in the CSI-RS resource and measurement configuration.

In some embodiments for SBFD operation, gNBs may exchange muting patterns that indicate symbols and frequency resources (sub-bands) within the carrier bandwidth.

For the above embodiments and examples, configurations for CLI-RS and/or muting patterns may repeat over multiple symbols within or across several slots. In some embodiments, such configurations may be necessary to allow for beam sweeping at the receiving gNBs. The signaling for such configurations with repetitions may follow existing NR specifications for configuration of CSI-RS or SRS resources with repetitions.

Note that for processes described above or below examples, the “gNB” may be replaced in general, by a transmit and receive point (TRP) and the cellular network may configure CLI-RS resource and measurement configuration for more than one TRPs. A TRP may transmit and measure the CLI-RS in accordance with the CLI-RS resource and measurement configuration. Furthermore, while many of the backhaul discussions above and below describe the Xn interface, the embodiments may alternatively apply to central unit-distributed unit (CU-DU) gNBs with split architecture (e.g., CU-DU split where a Distributed Unit (DU) may correspond to a TRP). In such embodiments, coordination/information exchange across different DUs may be realized over the F1 interface or other communication channels.

After receiving information on the CLI-RS resource and measurement configuration, CLI logic circuitry of the first gNB or the second gNB may mute the UL channel for transmission of the CLI-RS by the first gNB in accordance with the CLI-RS resource and measurement configuration (element 6010). In some embodiments, a first gNB or the second gNB may share information on resource muting patterns via backhaul signaling, e.g., Xn interface, with one or more neighboring gNBs. For example, such information may include configuration of Zero-Power CSI-RS (ZP-CSI-RS). The CLI logic circuitry of the first gNB may use a ZP-CSI-RS for a muting pattern when a (non-zero power) CSI-RS is used as the CLI-RS. In other embodiments, the logic circuitry of the first gNB may use a Zero-Power SRS (ZP-SRS) to define a muting pattern, where ZP-SRS corresponds to resource pattern as used for mapping of SRS to physical (time-frequency) resources. The logic circuitry of the first gNB may use the ZP-SRS when the SRS is used as the CLI-RS. In another embodiment, muting patterns may only include identification of OFDM symbols. In still other embodiments, the OFDM symbols may be limited to symbols indicated as DL or Flexible symbols in the TDD configuration provided by the first gNB to one or more neighboring gNBs.

The logic circuitry of the first gNB may use the muting patterns to indicate resources in which a gNB may be able to (or may intend to) receive a CLI-RS from neighboring gNBs, Such muting patterns may advantageously enable use of the CLI-RS resource and measurement configuration across a set of neighboring gNBs, efficiently coordinating CLI measurement based on a CLI-RS transmitted from each neighboring gNB (or multiple neighboring gNBs) in the set by the other neighboring gNBs in the set.

After receiving information on the CLI-RS resource and measurement configuration, CLI logic circuitry of the second gNB and possibly one or more neighboring gNBs, may measure CLI-RS in accordance with the CLI-RS resource and measurement configuration (element 6015). For example, measurements that do not include SBFD operations may be performed by the second gNB and the neighboring gNBs. In some embodiments, measurements that do include SBFD operations may be performed by the second gNB and not by the neighboring gNBs.

Based on the measurements by the second gNB and possibly the neighboring gNBs, the respective gNBs may generate CLI-RS measurement reports and transmit or share the CLI-RS measurement reports with the first gNB via backhaul signaling such as the Xn interface (element 6020). In some embodiments, the second gNB may also share the CLI-RS measurement report with the neighboring gNBs and vice versa. With the CLI-RS measurement reports, the gNBs may determine measures to mitigate the CLI experienced by the second gNB such as reducing transmission power, allocating flexible symbols of the communication resources subject to the measurement to UL communications instead of DL communications, and/or the like.

FIG. 6B illustrates an embodiment of a flowchart 6100 to measure and mitigate cross-link interference such as the embodiments described in conjunction with FIGS. 1A-1B, 2, 3, 4, and 5A-5C. The flowchart 6100 begins with transmitting, by a first gNB, information on CLI-RS resource and measurement configuration via backhaul signaling, e.g., Xn interface to one or more neighboring gNBs. In some embodiments, the first gNB may also transmit or share a muting pattern with the one or more neighboring gNBs.

After transmitting the CLI-RS resource and measurement configuration, the first gNB may transmit the CLI-RS on communication resources identified in the CLI-RS resource and measurement configuration or on communication resources identified for measurement in the CLI-RS resource and measurement configuration (element 6110). The CLI-RS resource and measurement configuration may also include an SBFD configuration if the correct SBFD configuration was not previously transmitted or otherwise known by the neighboring gNBs.

Thereafter, the first gNB may receive from the neighboring gNBs, one or more CLI-RS measurement reports via backhaul signaling through, e.g., an Xn interface (element 6115). In other embodiments, the neighbor gNBs may transmit or share the CLI-RS measurement reports via an F1 interface or another communication resource.

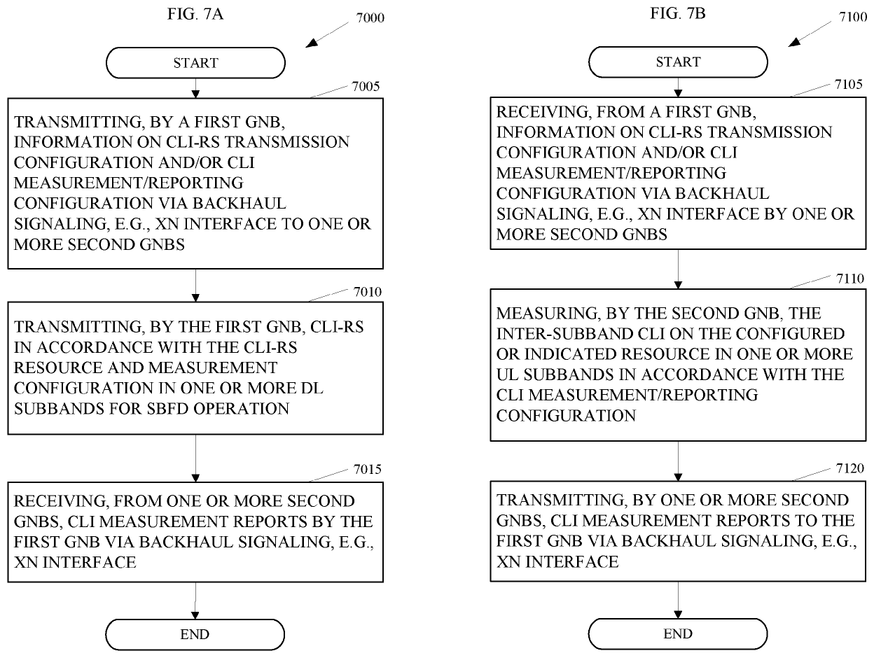

FIGS. 7A-B depict flowcharts of alternative embodiments to measure and mitigate cross-link interference such as the embodiments described in conjunction with FIGS. 1A-1B, 2, 3, 4, and 5A-5C. FIG. 7A illustrates an embodiment of a flowchart 7000. At the beginning of the flowchart 7000, CLI logic circuitry of the first gNB may cause transmission of information on CLI-RS transmission configuration and/or CLI-RS measurement reporting configuration via backhaul signaling, e.g., Xn interface to one or more second gNBs (element 7005). In some embodiments, portions of the CLI-RS resource and measurement configuration may have already been sent to the one or more second gNBs for prior measurements or may otherwise be known or established so the first gNB may only send changes to parameters, formerly unknown parameters, or variable parameters of the CLI-RS resource and measurement configuration for the present measurements and reporting such as a CLI-RS transmission configuration and/or a CLI-RS measurement reporting configuration. In some embodiments, the CLI-RS resource and measurement configuration may comprise subsets of parameters and each subset may be sent separately or may be assumed to remain the same as the previously sent subsets of parameters (or as default parameter settings) unless new or different parameters are sent to the one or more second gNBs.

After transmitting the CLI-RS transmission configuration and/or CLI-RS measurement reporting configuration, the first gNB may transmit the CLI-RS in accordance with the CLI-RS resource and measurement configuration in one or more DL subbands for SBFD operation (element 7010). Thereafter, the first gNB may receive CLI-RS measurement reports from one or more second gNBs via backhaul signaling, e.g., Xn interface (7015). For instance, the second gNB measures the inter-subband CLI. In one example, the second gNB performs measurement on the configured or indicated communication resources, e.g., in one or more UL subbands in accordance with the CLI-RS resource and measurement configuration. In some embodiments, the second gNB can perform measurement on communication resources in one or more UL subbands according to SBFD configuration of the second gNB. In another embodiment, the communication resources on which the second gNB performs measurement may be coordinated between the first and second gNBs. This can include indication of one or more candidate communication resources for measurements by the second gNB that may be further confirmed or negotiated between the two gNBs. In a further embodiment, the measurement resources may be limited to communication resources that correspond to time domain symbols with the configured or indicated CLI-RS resources in which the first gNB may transmit CLI-RS. Accordingly, the first gNB may further realize resource blanking by avoidance of scheduling transmission or reception in the communication resources identified for measurement by the second gNB other than communication resources that correspond to time domain symbols with the configured or indicated CLI-RS resources in which the first gNB may transmit CLI-RS. In other words, the first gNB may transmit the CLI-RS during designated CLI-RS communication resources but not transmit during the remaining communication resources designated for measurement by one or more of the second gNBs.

In some embodiments, L1 or L3 CLI-signal to noise and interference ratio (CLI-SINR) or CLI-RSRP may be used for the CLI measurement report that may be reported from a gNB. In some embodiments, a set of time and frequency resources for CLI-RSSI measurement and report can be configured and shared among the gNBs. The set of frequency resources may be contiguous or non-contiguous. Further, in order to measure inter-subband CLI, the frequency resources may be located within a UL subband.

In some embodiments, a CLI measurement resource may span across more than one UL subband. When the more than one UL subbands are not contiguous in frequency, the CLI measurement resource can also be non-contiguous in frequency. In some embodiments, one CLI measurement value, e.g., a CLI-RSSI may be generated for a single CLI measurement resource. In addition, one or more than one CLI measurement values, e.g., multiple CLI-RSSIs may be included in a CLI-RS measurement report. The number of CLI-RSSI values within a CLI-RS measurement report may be determined in accordance with the number of CLI measurement resources. In some embodiments, in a CLI-RS measurement report, a gNB may include TCI state information used for the CLI-RS measurement.

FIG. 7B illustrates an embodiment of a flowchart 7000 to measure and mitigate cross-link interference such as the embodiments described in conjunction with FIGS. 1A-1B, 2, 3, 4, and 5A-5C. At the beginning of the flowchart 7100, CLI logic circuitry of one or more second gNBs may receive information on CLI-RS transmission configuration and/or CLI-RS measurement reporting configuration via backhaul signaling, e.g., Xn interface to one or more second gNBs (element 7105). The one or more second gNBs may measure the inter-subband CLI on the configured or indicated resource in one or more UL subbands in accordance with the CLI-RS measurement reporting configuration of the CLI-RS resource and measurement configuration (element 7110). Thereafter, the CLI logic circuitry of the one or more second gNBs may transmit CLI-RS measurement reports to the first gNB via backhaul signaling. In some embodiments, one or more or all parameters of the CLI-RS resource and measurement configuration may be negotiated by one or more of the second gNBs with the first gNB prior to transmission of the CLI-RS. Such negotiations may involve transmission of capabilities for each of the parameters by the first gNB, receipt of capabilities from the one or more second gNBs, and selection of the one or more parameters of the CLI-RS resource and measurement configuration prior to transmission of the CLI-RS resource and measurement configuration. In further embodiments, such negotiations may involve transmission of capabilities for each of the parameters by the first gNB, receipt of one or more parameters based on the capabilities from the one or more second gNBs, in lieu of transmission of the CLI-RS resource and measurement configuration. In still further embodiments, such negotiations may involve transmission of one or more parameters in the CLI-RS resource and measurement configuration by the first gNB, receipt of capabilities from each of the second gNBs, and transmission of the CLI-RS resource and measurement configuration based on the capabilities received from each of the second gNBs.

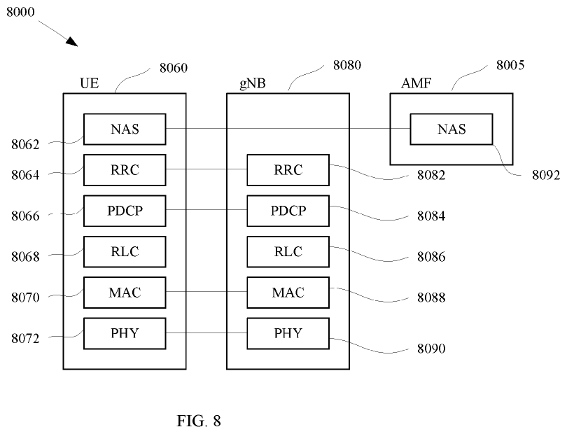

FIG. 8 depicts an embodiment of protocol entities 8000 that may be implemented in wireless communication devices, including one or more of a user equipment (UE) 8060, a base station, which may be termed an evolved node B (eNB), or a new radio, next generation node B (gNB) 8080, and a network function, which may be termed a mobility management entity (MME), or an access and mobility management function (AMF) 8094, according to some aspects.

According to some aspects, gNB 8080 may be implemented as one or more of a dedicated physical device such as a macro-cell, a femto-cell or other suitable device, or in an alternative aspect, may be implemented as one or more software entities running on server computers as part of a virtual network termed a cloud radio access network (CRAN).

According to some aspects, one or more protocol entities that may be implemented in one or more of UE 8060, gNB 8080 and AMF 8094, may be described as implementing all or part of a protocol stack in which the layers are considered to be ordered from lowest to highest in the order physical layer (PHY), medium access control (MAC), radio link control (RLC), packet data convergence protocol (PDCP), radio resource control (RRC) and non-access stratum (NAS). According to some aspects, one or more protocol entities that may be implemented in one or more of UE 8060, gNB 8080 and AMF 8094, may communicate with a respective peer protocol entity that may be implemented on another device, using the services of respective lower layer protocol entities to perform such communication.

According to some aspects, UE PHY layer 8072 and peer entity gNB PHY layer 8090 may communicate using signals transmitted and received via a wireless medium. According to some aspects, UE MAC layer 8070 and peer entity gNB MAC layer 8088 may communicate using the services provided respectively by UE PHY layer 872 and gNB PHY layer 8090. According to some aspects, UE RLC layer 8068 and peer entity gNB RLC layer 8086 may communicate using the services provided respectively by UE MAC layer 8070 and gNB MAC layer 8088. According to some aspects, UE PDCP layer 8066 and peer entity gNB PDCP layer 8084 may communicate using the services provided respectively by UE RLC layer 8068 and 5GNB RLC layer 8086. According to some aspects, UE RRC layer 8064 and gNB RRC layer 8082 may communicate using the services provided respectively by UE PDCP layer 8066 and gNB PDCP layer 8084. According to some aspects, UE NAS 8062 and AMF NAS 8092 may communicate using the services provided respectively by UE RRC layer 8064 and gNB RRC layer 8082.

The PHY layer 8072 and 8090 may transmit or receive information used by the MAC layer 8070 and 8088 over one or more air interfaces. The PHY layer 8072 and 8090 may further perform link adaptation or adaptive modulation and coding (AMC), power control, cell search (e.g., for initial synchronization and handover purposes), and other measurements used by higher layers, such as the RRC layer 8064 and 8082. The PHY layer 8072 and 8090 may still further perform error detection on the transport channels, forward error correction (FEC) coding/decoding of the transport channels, modulation/demodulation of physical channels, interleaving, rate matching, mapping onto physical channels, and Multiple Input Multiple Output (MIMO) antenna processing.

The MAC layer 8070 and 8088 may perform mapping between logical channels and transport channels, multiplexing of MAC service data units (SDUs) from one or more logical channels onto transport blocks (TB) to be delivered to PHY via transport channels, de-multiplexing MAC SDUs to one or more logical channels from transport blocks (TB) delivered from the PHY via transport channels, multiplexing MAC SDUs onto TBs, scheduling information reporting, error correction through hybrid automatic repeat request (HARQ), and logical channel prioritization.

The RLC layer 8068 and 8086 may operate in a plurality of modes of operation, including: Transparent Mode (TM), Unacknowledged Mode (UM), and Acknowledged Mode (AM). The RLC layer 8068 and 8086 may execute transfer of upper layer protocol data units (PDUs), error correction through automatic repeat request (ARQ) for AM data transfers, and concatenation, segmentation and reassembly of RLC SDUs for UM and AM data transfers. The RLC layer 8068 and 8086 may also execute re-segmentation of RLC data PDUs for AM data transfers, reorder RLC data PDUs for UM and AM data transfers, detect duplicate data for UM and AM data transfers, discard RLC SDUs for UM and AM data transfers, detect protocol errors for AM data transfers, and perform RLC re-establishment.

The PDCP layer 8066 and 8084 may execute header compression and decompression of Internet Protocol (IP) data, maintain PDCP Sequence Numbers (SNs), perform in-sequence delivery of upper layer PDUs at re-establishment of lower layers, eliminate duplicates of lower layer SDUs at re-establishment of lower layers for radio bearers mapped on RLC AM, cipher and decipher control plane data, perform integrity protection and integrity verification of control plane data, control timer-based discard of data, and perform security operations (e.g., ciphering, deciphering, integrity protection, integrity verification, etc.).

The main services and functions of the RRC layer 8064 and 8082 may include broadcast of system information (e.g., included in Master Information Blocks (MIBs) or System Information Blocks (SIBs) related to the non-access stratum (NAS)), broadcast of system information related to the access stratum (AS), paging, establishment, maintenance and release of an RRC connection between the UE and E-UTRAN (e.g., RRC connection paging, RRC connection establishment, RRC connection modification, and RRC connection release), establishment, configuration, maintenance and release of point to point Radio Bearers, security functions including key management, inter radio access technology (RAT) mobility, and measurement configuration for UE measurement reporting. Said MIBs and SIBs may comprise one or more information elements (IEs), which may each comprise individual data fields or data structures.

The UE 8060 and the RAN node, gNB 8080 may utilize a Uu interface (e.g., an LTE-Uu interface) to exchange control plane data via a protocol stack comprising the PHY layer 8072 and 8090, the MAC layer 8070 and 8088, the RLC layer 8068 and 8086, the PDCP layer 8066 and 8084, and the RRC layer 8064 and 8082.

The non-access stratum (NAS) protocols 8092 form the highest stratum of the control plane between the UE 8060 and the AMF 8005. The NAS protocols 8092 support the mobility of the UE 8060 and the session management procedures to establish and maintain IP connectivity between the UE 8060 and the Packet Data Network (PDN) Gateway (P-GW).

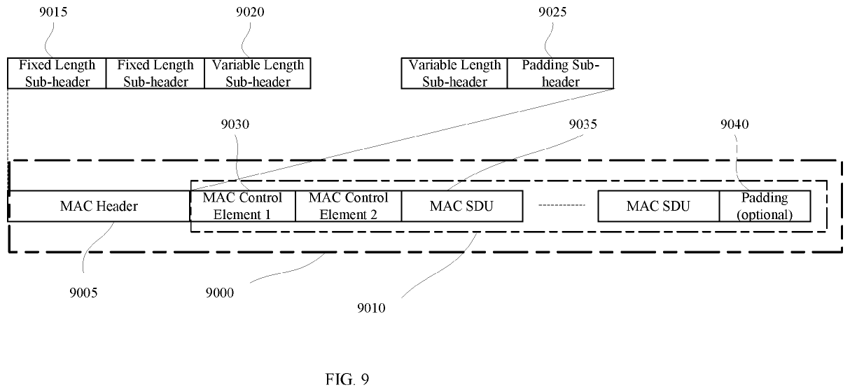

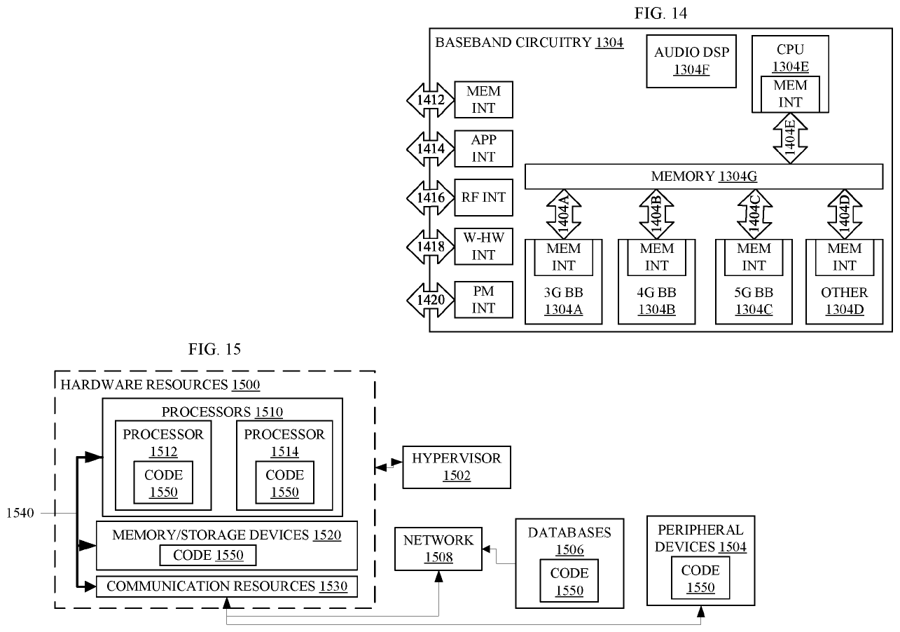

FIG. 9 illustrates embodiments of the formats of PHY data units (PDUs) that may be transmitted by the PHY device via one or more antennas and be encoded and decoded by a MAC entity such as the processors 203 and 213 in FIG. 2, the baseband circuitry 1304 in FIGS. 13 and 14 according to some aspects. In several embodiments, higher layer frames such as a frame comprising an RRC layer information element may transmit from the base station to the UE or vice versa as one or more MAC Service Data Units (MSDUs) in a payload of one or more PDUs in one or more subframes of a radio frame.

According to some aspects, a MAC PDU 9100 may consist of a MAC header 9105 and a MAC payload 9110, the MAC payload consisting of zero or more MAC control elements 9130, zero or more MAC service data unit (SDU) portions 9135 and zero or one padding portion 9140. According to some aspects, MAC header 8105 may consist of one or more MAC sub-headers, each of which may correspond to a MAC payload portion and appear in corresponding order. According to some aspects, each of the zero or more MAC control elements 9130 contained in MAC payload 9110 may correspond to a fixed length sub-header 9115 contained in MAC header 9105. According to some aspects, each of the zero or more MAC SDU portions 9135 contained in MAC payload 9110 may correspond to a variable length sub-header 9120 contained in MAC header 8105. According to some aspects, padding portion 9140 contained in MAC payload 9110 may correspond to a padding sub-header 9125 contained in MAC header 9105.

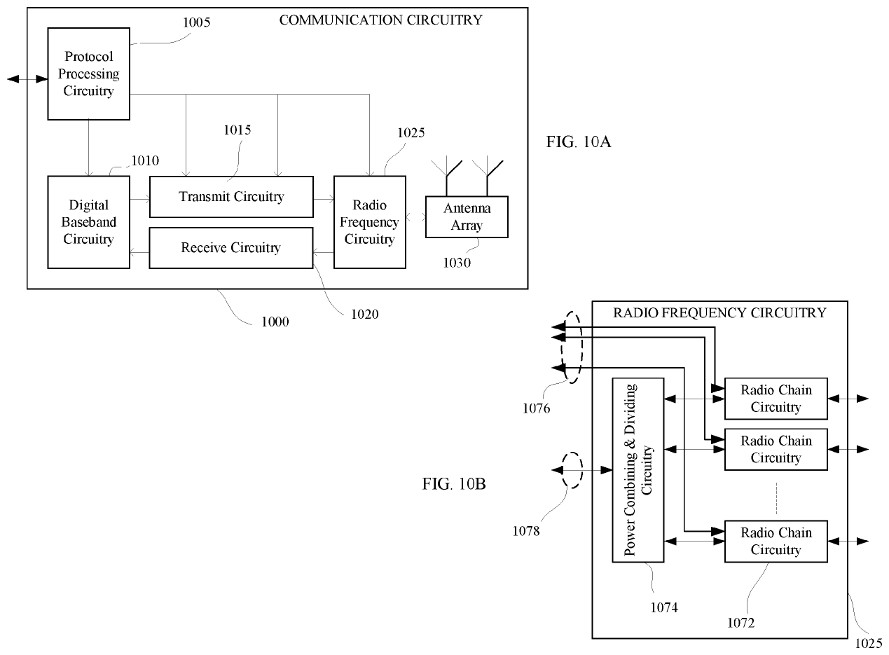

FIG. 10A illustrates an embodiment of communication circuitry 1000 such as the circuitry in the base station 201 and the user equipment 211 shown in FIG. 2. The communication circuitry 1000 is alternatively grouped according to functions. Components as shown in the communication circuitry 1000 are shown here for illustrative purposes and may include other components not shown here in FIG. 10A.

The communication circuitry 1000 may include protocol processing circuitry 1005, which may implement one or more of medium access control (MAC), radio link control (RLC), packet data convergence protocol (PDCP), radio resource control (RRC) and non-access stratum (NAS) functions. The protocol processing circuitry 1005 may include one or more processing cores (not shown) to execute instructions and one or more memory structures (not shown) to store program (code) and data information.

The communication circuitry 1000 may further include digital baseband circuitry 1010, which may implement physical layer (PHY) functions including one or more of hybrid automatic repeat request (HARQ) functions, scrambling and/or descrambling, coding and/or decoding, layer mapping and/or de-mapping, modulation symbol mapping, received symbol and/or bit metric determination, multi-antenna port pre-coding and/or decoding which may include one or more of space-time, space-frequency or spatial coding, reference signal generation and/or detection, preamble sequence generation and/or decoding, synchronization sequence generation and/or detection, control channel signal blind decoding, and other related functions.

The communication circuitry 1000 may further include transmit circuitry 1015, receive circuitry 1020 and/or antenna array 1030 circuitry.

The communication circuitry 1000 may further include radio frequency (RF) circuitry 1025 such as the RF circuitry 208 and 218 in FIG. 2. In an aspect of an embodiment, RF circuitry 1025 may include multiple parallel RF chains for one or more of transmit or receive functions, each connected to one or more antennas of the antenna array 1030.

In an aspect of the disclosure, the protocol processing circuitry 1005 may include one or more instances of control circuitry (not shown) to provide control functions for one or more of digital baseband circuitry 1010, transmit circuitry 1015, receive circuitry 1020, and/or radio frequency circuitry 1025.

FIG. 10B illustrates an embodiment of radio frequency circuitry 1025 in FIG. 10A according to some aspects such as a RF circuitry 208 and 218 illustrated in FIG. 2. The radio frequency circuitry 1025 may include one or more instances of radio chain circuitry 1072, which in some aspects may include one or more filters, power amplifiers, low noise amplifiers, programmable phase shifters and power supplies (not shown).

The radio frequency circuitry 1025 may include power combining and dividing circuitry 1074.

In some aspects, power combining and dividing circuitry 1074 may operate bidirectionally, such that the same physical circuitry may be configured to operate as a power divider when the device is transmitting, and as a power combiner when the device is receiving. In some aspects, power combining and dividing circuitry 1074 may one or more include wholly or partially separate circuitries to perform power dividing when the device is transmitting and power combining when the device is receiving. In some aspects, power combining and dividing circuitry 1074 may include passive circuitry comprising one or more two-way power divider/combiners arranged in a tree. In some aspects, power combining and dividing circuitry 1074 may include active circuitry comprising amplifier circuits.

In some aspects, the radio frequency circuitry 1025 may connect to transmit circuitry 1015 and receive circuitry 1020 in FIG. 10A via one or more radio chain interfaces 1076 or a combined radio chain interface 1078. The combined radio chain interface 1078 may form a wide or very wide bandwidth.

In some aspects, one or more radio chain interfaces 1076 may provide one or more interfaces to one or more receive or transmit signals, each associated with a single antenna structure which may comprise one or more antennas.

In some aspects, the combined radio chain interface 1078 may provide a single interface to one or more receive or transmit signals, each associated with a group of antenna structures comprising one or more antennas.

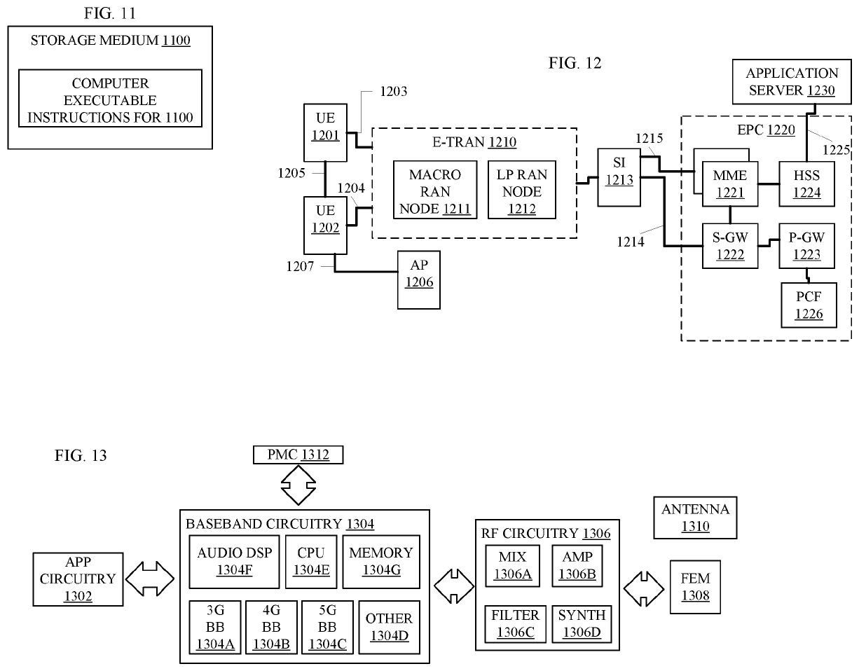

FIG. 11 illustrates an example of a storage medium 1100 to store code and data for execution by any one or more of the processors and/or processing circuitry described herein. Storage medium 1100 may comprise an article of manufacture. In some examples, storage medium 1100 may include any non-transitory computer readable medium or machine-readable medium, such as an optical, magnetic or semiconductor storage. Storage medium 1100 may store diverse types of computer executable instructions, such as instructions to implement logic flows and/or techniques described herein. Examples of a computer readable or machine-readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like.

FIG. 12 illustrates an architecture of a system 1200 of a network in accordance with some embodiments. The system 1200 is shown to include a user equipment (UE) 1201 and a UE 1202 such as the UEs shown in FIGS. 1A-1B, and 2. The UEs 1201 and 1202 are illustrated as smartphones (e.g., handheld touch screen mobile computing devices connectable to one or more cellular networks) but may also comprise any mobile or non-mobile computing device, such as Personal Data Assistants (PDAs), pagers, laptop computers, desktop computers, wireless handsets, or any computing device including a wireless communications interface.

In some embodiments, any of the UEs 1201 and 1202 can comprise an Internet of Things (IoT) UE, which can comprise a network access layer designed for low-power IoT applications utilizing short-lived UE connections. An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network.

The UEs 1201 and 1202 may to connect, e.g., communicatively couple, with a radio access network (RAN)—in this embodiment, an Evolved Universal Mobile Telecommunications System (UMTS) Terrestrial Radio Access Network (E-UTRAN) 1210 such as the base stations shown in FIGS. 1A-1B, and 2. The UEs 1201 and 1202 utilize connections 1203 and 1204, respectively, each of which comprises a physical communications interface or layer (discussed in further detail below); in this example, the connections 1203 and 1204 are illustrated as an air interface to enable communicative coupling, and can be consistent with cellular communications protocols, such as a

Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth generation (5G) protocol, a New Radio (NR) protocol, and the like.

In this embodiment, the UEs 1201 and 1202 may further directly exchange communication data via a ProSe interface 1205. The ProSe interface 1205 may alternatively be referred to as a sidelink interface comprising one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

The UE 1202 is shown to be configured to access an access point (AP) 1206 via connection 1207. The connection 1207 can comprise a local wireless connection, such as a connection consistent with any IEEE 802.11 protocol, wherein the AP 1206 would comprise a wireless fidelity (WiFi®) router. In this example, the AP 1206 is shown to be connected to the Internet without connecting to the core network of the wireless system (described in further detail below). The E-UTRAN 1210 can include one or more access nodes that enable the connections 1203 and 1204.

These access nodes (ANs) can be referred to as base stations (BSs), NodeBs, evolved NodeBs (eNBs), next Generation NodeBs (gNB), RAN nodes, and so forth, and can comprise ground stations (e.g., terrestrial access points) or satellite stations providing coverage within a geographic area (e.g., a cell). The E-UTRAN 1210 may include one or more RAN nodes for providing macro-cells, e.g., macro RAN node 1211, and one or more RAN nodes for providing femto-cells or picocells (e.g., cells having smaller coverage areas, smaller user capacity, or higher bandwidth compared to macro-cells), e.g., low power (LP) RAN node 1212.

Any of the RAN nodes 1211 and 1212 can terminate the air interface protocol and can be the first point of contact for the UEs 1201 and 1202. In some embodiments, any of the RAN nodes 1211 and 1212 can fulfill various logical functions for the E-UTRAN 1210 including, but not limited to, radio network controller (RNC) functions such as radio bearer management, uplink and downlink dynamic radio resource management and data packet scheduling, and mobility management.

In accordance with some embodiments, the UEs 1201 and 1202 can be configured to communicate using Orthogonal Frequency-Division Multiplexing (OFDM) communication signals with each other or with any of the RAN nodes 1211 and 1212 over a multicarrier communication channel in accordance various communication techniques, such as, but not limited to, an Orthogonal Frequency-Division Multiple Access (OFDMA) communication technique (e.g., for downlink communications) or a Single Carrier Frequency Division Multiple Access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, a downlink resource grid can be used for downlink transmissions from any of the RAN nodes 1211 and 1212 to the UEs 1201 and 1202, while uplink transmissions can utilize similar techniques. The grid can be a time-frequency grid, called a resource grid or time-frequency resource grid, which is the physical resource in the downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises a number of resource blocks, which describe the mapping of certain physical channels to resource elements. Each resource block comprises a collection of resource elements; in the frequency domain, this may represent the smallest quantity of resources that currently can be allocated. There are several different physical downlink (DL) channels that are conveyed using such resource blocks.

The physical downlink shared channel (PDSCH) may carry user data and higher layer signaling to the UEs 1201 and 1202. The physical downlink control channel (PDCCH) may carry information about the transport format and resource allocations related to the PDSCH channel, among other things. It may also inform the UEs 1201 and 1202 about the transport format, resource allocation, and HARQ (Hybrid Automatic Repeat Request) information related to the uplink shared channel. Typically, downlink scheduling (assigning control and shared channel resource blocks to the UE 102 within a cell) may be performed at any of the RAN nodes 1211 and 1212 based on channel quality information fed back from any of the UEs 1201 and 1202. The downlink resource assignment information may be sent on the PDCCH used for (e.g., assigned to) each of the UEs 1201 and 1202.

The PDCCH may use control channel elements (CCEs) to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as resource element groups (REGs). Four Quadrature Phase Shift Keying (QPSK) symbols may be mapped to each REG. The PDCCH can be transmitted using one or more CCEs, depending on the size of the downlink control information (DCI) and the channel condition. There can be four or more different PDCCH formats defined in LTE with different numbers of CCEs (e.g., aggregation level, L=1, 2, 4, or 8).

Some embodiments may use concepts for resource allocation for control channel information that are an extension of the above-described concepts. For example, some embodiments may utilize an enhanced physical downlink control channel (EPDCCH) that uses PDSCH resources for control information transmission. The EPDCCH may be transmitted using one or more enhanced the control channel elements (ECCEs). Similar to above, each ECCE may correspond to nine sets of four physical resource elements known as an enhanced resource element groups (EREGs). An ECCE may have other numbers of EREGs in some situations.

The RAN nodes 1211 and 1212 may communicate with one another and/or with other access nodes in the E-UTRAN 1210 and/or in another RAN via an X2 interface, which is a signaling interface for communicating data packets between ANs. Some other suitable interface for communicating data packets directly between ANs may be used.

The E-UTRAN 1210 is shown to be communicatively coupled to a core network-in this embodiment, an Evolved Packet Core (EPC) network 1220 via an SI interface 1213. In this embodiment the SI interface 1213 is split into two parts: the SI-U interface 1214, which carries traffic data between the RAN nodes 1211 and 1212 and the serving gateway (S-GW) 1222, and the SI-mobility management entity (MME) interface 1215, which is a signaling interface between the RAN nodes 1211 and 1212 and MMEs 1221.

In this embodiment, the EPC network 1220 comprises the MMEs 1221, the S-GW 1222, the Packet Data Network (PDN) Gateway (P-GW) 1223, and a home subscriber server (HSS) 1224. The MMEs 1221 may be similar in function to the control plane of legacy Serving General Packet Radio Service (GPRS) Support Nodes (SGSN). The MMEs 1221 may manage mobility aspects in access such as gateway selection and tracking area list management. The HSS 1224 may comprise a database for network users, including subscription-related information to support the network entities' handling of communication sessions. The EPC network 1220 may comprise one or several HSSs 1224, depending on the number of mobile subscribers, on the capacity of the equipment, on the organization of the network, etc. For example, the HSS 1224 can provide support for routing/roaming, authentication, authorization, naming/addressing resolution, location dependencies, etc.

The S-GW 1222 may terminate the SI interface 1213 towards the E-UTRAN 1210, and routes data packets between the E-UTRAN 1210 and the EPC network 1220. In addition, the S-GW 1222 may be a local mobility anchor point for inter-RAN node handovers and also may provide an anchor for inter-3GPP mobility. Other responsibilities may include lawful intercept, charging, and some policy enforcement.

The P-GW 1223 may terminate an SGi interface toward a PDN. The P-GW 1223 may route data packets between the EPC network 1220 and external networks such as a network including the application server 1230 (alternatively referred to as application function (AF)) via an Internet Protocol (IP) interface 1225. Generally, the application server 1230 may be an element offering applications that use IP bearer resources with the core network (e.g., UMTS Packet Services (PS) domain, LTE PS data services, etc.). In this embodiment, the P-GW 1223 is shown to be communicatively coupled to an application server 1230 via an IP interface 1225. The application server 1230 can also be configured to support one or more communication services (e.g., Voice-over-Internet Protocol (VOIP) sessions, PTT sessions, group communication sessions, social networking services, etc.) for the UEs 1201 and 1202 via the EPC network 1220.

The P-GW 1223 may further be a node for policy enforcement and charging data collection. Policy and Charging Enforcement Function (PCRF) 1226 is the policy and charging control element of the EPC network 1220. In a non-roaming scenario, there may be a single PCRF in the Home Public Land Mobile Network (HPLMN) associated with a UE's Internet Protocol Connectivity Access Network (IP-CAN) session. In a roaming scenario with local breakout of traffic, there may be two PCRFs associated with a UE's IP-CAN session: a Home PCRF (H-PCRF) within a HPLMN and a Visited PCRF (V-PCRF) within a Visited Public Land Mobile Network (VPLMN). The PCRF 1226 may be communicatively coupled to the application server 1230 via the P-GW 1223. The application server 1230 may signal the PCRF 1226 to indicate a new service flow and select the appropriate Quality of Service (QOS) and charging parameters. The PCRF 1226 may provision this rule into a Policy and Charging Enforcement Function (PCEF) (not shown) with the appropriate traffic flow template (TFT) and QoS class of identifier (QCI), which commences the QoS and charging as specified by the application server 1230.

FIG. 13 illustrates example components of a device 1300 in accordance with some embodiments such as the base stations and UEs shown in FIGS. 1A-1B, 2, and 12. In some embodiments, the device 1300 may include application circuitry 1302, baseband circuitry 1304, Radio Frequency (RF) circuitry 1306, front-end module (FEM) circuitry 1308, one or more antennas 1310, and power management circuitry (PMC) 1312 coupled together at least as shown. The components of the illustrated device 1300 may be included in a UE or a RAN node such as a base station or gNB. In some embodiments, the device 1300 may include less elements (e.g., a RAN node may not utilize application circuitry 1302, and instead include a processor/controller to process IP data received from an EPC). In some embodiments, the device 1300 may include additional elements such as, for example, memory/storage, display, camera, sensor, or input/output (I/O) interface. In other embodiments, the components described below may be included in more than one device (e.g., said circuitries may be separately included in more than one device for Cloud-RAN (C-RAN) implementations).

The application circuitry 1302 may include one or more application processors. For example, the application circuitry 1302 may include circuitry such as, but not limited to, one or more single-core or multi-core processors. The processor(s) may include any combination of general-purpose processors and dedicated processors (e.g., graphics processors, application processors, etc.). The processors may be coupled with or may include memory/storage and may be configured to execute instructions stored in the memory/storage to enable various applications or operating systems to run on the device 1300. In some embodiments, processors of application circuitry 1302 may process IP data packets received from an EPC.

The baseband circuitry 1304 may include circuitry such as, but not limited to, one or more single-core or multi-core processors. The baseband circuitry 1304 may include one or more baseband processors or control logic to process baseband signals received from a receive signal path of the RF circuitry 1306 and to generate baseband signals for a transmit signal path of the RF circuitry 1306. The baseband circuity 1304 may interface with the application circuitry 1302 for generation and processing of the baseband signals and for controlling operations of the RF circuitry 1306. For example, in some embodiments, the baseband circuitry 1304 may include a third generation (3G) baseband processor 1304A, a fourth generation (4G) baseband processor 1304B, a fifth generation (5G) baseband processor 1304C, or other baseband processor(s) 1304D for other existing generations, generations in development or to be developed in the future (e.g., second generation (2G), sixth generation (6G), etc.). In many embodiments, the fourth generation (4G) baseband processor 1304B may include capabilities for generation and processing of the baseband signals for LTE radios and the fifth generation (5G) baseband processor 1304C may capabilities for generation and processing of the baseband signals for NRs.

The baseband circuitry 1304 (e.g., one or more of baseband processors 1304A-D) may handle various radio control functions that enable communication with one or more radio networks via the RF circuitry 1306. In other embodiments, some of or all the functionality of baseband processors 1304A-D may be included in modules stored in the memory 1304G and executed via a Central Processing Unit (CPU) 1304E. The radio control functions may include, but are not limited to, signal modulation/demodulation, encoding/decoding, radio frequency shifting, etc.

In some embodiments, modulation/demodulation circuitry of the baseband circuitry 1304 may include Fast-Fourier Transform (FFT), precoding, or constellation mapping/demapping functionality. In some embodiments, encoding/decoding circuitry of the baseband circuitry 1304 may include convolution, tail-biting convolution, turbo, Viterbi, or Low-Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 1304 may include one or more audio digital signal processor(s) (DSP) 1304F. The audio DSP(s) 1304F may be include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some of or all the constituent components of the baseband circuitry 1304 and the application circuitry 1302 may be implemented together such as, for example, on a system on a chip (SOC). In some embodiments, the baseband circuitry 1304 may provide for communication compatible with one or more radio technologies. For example, in some embodiments, the baseband circuitry 1304 may support communication with an evolved universal terrestrial radio access network (E-UTRAN) or other wireless metropolitan area networks (WMAN), a wireless local area network (WLAN), a wireless personal area network (WPAN). Embodiments in which the baseband circuitry 1304 is configured to support radio communications of more than one wireless protocol may be referred to as multi-mode baseband circuitry.

The RF circuitry 1306 may enable communication with wireless networks using modulated electromagnetic radiation through a non-solid medium. In various embodiments, the RF circuitry 1306 may include switches, filters, amplifiers, etc. to facilitate the communication with the wireless network. The RF circuitry 1306 may include a receive signal path which may include circuitry to down-convert RF signals received from the FEM circuitry 1308 and provide baseband signals to the baseband circuitry 1304. The RF circuitry 1306 may also include a transmit signal path which may include circuitry to up-convert baseband signals provided by the baseband circuitry 1304 and provide RF output signals to the FEM circuitry 1308 for transmission.

In some embodiments, the receive signal path of the RF circuitry 1306 may include mixer circuitry 1306a, amplifier circuitry 1306b and filter circuitry 1306c. In some embodiments, the transmit signal path of the RF circuitry 1306 may include filter circuitry 1306c and mixer circuitry 1306a. The RF circuitry 1306 may also include synthesizer circuitry 1306d for synthesizing a frequency, or component carrier, for use by the mixer circuitry 1306a of the receive signal path and the transmit signal path. In some embodiments, the mixer circuitry 1306a of the receive signal path may to down-convert RF signals received from the FEM circuitry 1308 based on the synthesized frequency provided by synthesizer circuitry 1306d. The amplifier circuitry 1306b may amplify the down-converted signals and the filter circuitry 1306c may be a low-pass filter (LPF) or band-pass filter (BPF) to remove unwanted signals from the down-converted signals to generate output baseband signals. Output baseband signals may be provided to the baseband circuitry 1304 for further processing.

In some embodiments, the output baseband signals may be zero-frequency baseband signals, although this is not a requirement. In some embodiments, mixer circuitry 1306a of the receive signal path may comprise passive mixers, although the scope of the embodiments is not limited in this respect.

In some embodiments, the mixer circuitry 1306a of the transmit signal path may be configured to up-convert input baseband signals based on the synthesized frequency provided by the synthesizer circuitry 1306d to generate RF output signals for the FEM circuitry 1308. The baseband signals may be provided by the baseband circuitry 1304 and may be filtered by filter circuitry 1306c.

In some embodiments, the mixer circuitry 1306a of the receive signal path and the mixer circuitry 1306a of the transmit signal path may include two or more mixers and may be arranged for quadrature downconversion and upconversion, respectively. In some embodiments, the mixer circuitry 1306a of the receive signal path and the mixer circuitry 1306a of the transmit signal path may include two or more mixers and may be arranged for image rejection (e.g., Hartley image rejection). In some embodiments, the mixer circuitry 1306a of the receive signal path and the mixer circuitry 1306a may be arranged for direct downconversion and direct upconversion, respectively. In some embodiments, the mixer circuitry 1306a of the receive signal path and the mixer circuitry 1306a of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 1306 may include analog-to-digital converter (ADC) and digital-to-analog converter (DAC) circuitry and the baseband circuitry 1304 may include a digital baseband interface to communicate with the RF circuitry 1306.

In some dual-mode embodiments, a separate radio IC circuitry may be provided for processing signals for each spectrum, although the scope of the embodiments is not limited in this respect.

In some embodiments, the synthesizer circuitry 1306d may be a fractional-N synthesizer or a fractional NIN+I synthesizer, although the scope of the embodiments is not limited in this respect as other types of frequency synthesizers may be suitable. For example, synthesizer circuitry 1306d may be a delta-sigma synthesizer, a frequency multiplier, or a synthesizer comprising a phase-locked loop with a frequency divider.

The synthesizer circuitry 1306d may synthesize an output frequency for use by the mixer circuitry 1306a of the RF circuitry 1306 based on a frequency input and a divider control input. In some embodiments, the synthesizer circuitry 1306d may be a fractional NIN|I synthesizer.

In some embodiments, frequency input may be an output of a voltage-controlled oscillator (VCO), although that is not a requirement. Divider control input may be an output of either the baseband circuitry 1304 or an application processor of the applications circuitry 1302 depending on the desired output frequency. Some embodiments may determine a divider control input (e.g., N) from a look-up table based on a channel indicated by the applications circuitry 1302.

The synthesizer circuitry 1306d of the RF circuitry 1306 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may break a VCO period up into Nd equal packets of phase, where Nd is the number of delay elements in the delay line. In this way, the DLL provides negative feedback to help ensure that the total delay through the delay line is one VCO cycle.

In some embodiments, the synthesizer circuitry 1306d may generate a carrier frequency (or component carrier) as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a local oscillator (LO) frequency (fLO). In some embodiments, the RF circuitry 1306 may include an IQ/polar converter.

The FEM circuitry 1308 may include a receive signal path which may include circuitry to operate on RF signals received from one or more antennas 1310, amplify the received signals and provide the amplified versions of the received signals to the RF circuitry 1306 for further processing. FEM circuitry 1308 may also include a transmit signal path which may include circuitry configured to amplify signals for transmission provided by the RF circuitry 1306 for transmission by one or more of the one or more antennas 1310. In various embodiments, the amplification through the transmit or receive signal paths may be done solely in the RF circuitry 1306, solely in the FEM circuitry 1308, or in both the RF circuitry 1306 and the FEM circuitry 1308.

In some embodiments, the FEM circuitry 1308 may include a TX/RX switch to switch between transmit mode and receive mode operation. The FEM circuitry may include a receive signal path and a transmit signal path. The receive signal path of the FEM circuitry may include a low-noise amplifier (LNA) to amplify received RF signals and provide the amplified received RF signals as an output (e.g., to the RF circuitry 1306). The transmit signal path of the FEM circuitry 1308 may include a power amplifier (PA) to amplify input RF signals (e.g., provided by RF circuitry 1306), and one or more filters to generate RF signals for subsequent transmission (e.g., by one or more of the one or more antennas 1310).

In the present embodiment, the radio refers to a combination of the RF circuitry 130 and the FEM circuitry 1308. The radio refers to the portion of the circuitry that generates and transmits or receives and processes the radio signals. The RF circuitry 1306 includes a transmitter to generate the time domain radio signals with the data from the baseband signals and apply the radio signals to subcarriers of the carrier frequency that form the bandwidth of the channel. The PA in the FEM circuitry 1308 amplifies the tones for transmission and amplifies tones received from the one or more antennas 1310 via the LNA to increase the signal-to-noise ratio (SNR) for interpretation. In wireless communications, the FEM circuitry 1308 may also search for a detectable pattern that appears to be a wireless communication. Thereafter, a receiver in the RF circuitry 1306 converts the time domain radio signals to baseband signals via one or more functional modules such as the functional modules shown in the base station 201 and the user equipment 211 illustrated in FIG. 2.

In some embodiments, the PMC 1312 may manage power provided to the baseband circuitry 1304. In particular, the PMC 1312 may control power-source selection, voltage scaling, battery charging, or DC-to-DC conversion. The PMC 1312 may often be included when the device 1300 is capable of being powered by a battery, for example, when the device is included in a UE. The PMC 1312 may increase the power conversion efficiency while providing desirable implementation size and heat dissipation characteristics.

While FIG. 13 shows the PMC 1312 coupled only with the baseband circuitry 1304. However, in other embodiments, the PMC 1312 may be additionally or alternatively coupled with, and perform similar power management operations for, other components such as, but not limited to, application circuitry 1302, RF circuitry 1306, or FEM circuitry 1308.

In some embodiments, the PMC 1312 may control, or otherwise be part of, various power saving mechanisms of the device 1300. For example, if the device 1300 is in an RRC_Connected state, where it is still connected to the RAN node as it expects to receive traffic shortly, then it may enter a state known as Discontinuous Reception Mode (DRX) after a period of inactivity. During this state, the device 1300 may power down for brief intervals of time and thus save power.

If there is no data traffic activity for an extended period of time, then the device 1300 may transition off to an RRC Idle state, where it disconnects from the network and does not perform operations such as channel quality feedback, handover, etc. The device 1300 goes into a very low power state and it performs paging where again it periodically wakes up to listen to the network and then powers down again. The device 1300 may not receive data in this state, in order to receive data, it must transition back to RRC Connected state.

An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

The processors of the application circuitry 1302 and the processors of the baseband circuitry 1304 may be used to execute elements of one or more instances of a protocol stack. For example, processors of the baseband circuitry 1304, alone or in combination, may be used execute Layer 3, Layer 2, or Layer 1 functionality, while processors of the application circuitry 1302 may utilize data (e.g., packet data) received from these layers and further execute Layer 4 functionality (e.g., transmission communication protocol (TCP) and user datagram protocol (UDP) layers). As referred to herein, Layer 3 may comprise a radio resource control (RRC) layer, described in further detail below. As referred to herein, Layer 2 may comprise a medium access control (MAC) layer, a radio link control (RLC) layer, and a packet data convergence protocol (PDCP) layer, described in further detail below. As referred to herein, Layer 1 may comprise a physical (PHY) layer of a UE/RAN node, described in further detail below.

FIG. 14 illustrates example interfaces of baseband circuitry in accordance with some embodiments such as the baseband circuitry shown in FIGS. 1A, 2, and 13. As discussed above, the baseband circuitry 1304 of FIG. 13 may comprise processors 1304A-1304E and a memory 1304G utilized by said processors. Each of the processors 1304A-1304E may include a memory interface, 1404A-1404E, respectively, to send/receive data to/from the memory 1304G.

The baseband circuitry 1304 may further include one or more interfaces to communicatively couple to other circuitries/devices, such as a memory interface 1412 (e.g., an interface to send/receive data to/from memory external to the baseband circuitry 1304), an application circuitry interface 1414 (e.g., an interface to send/receive data to/from the application circuitry 1302 of FIG. 13), an RF circuitry interface 1416 (e.g., an interface to send/receive data to/from RF circuitry 1306 of FIG. 13), a wireless hardware connectivity interface 1418 (e.g., an interface to send/receive data to/from Near Field Communication (NFC) components, Bluetooth® components (e.g., Bluetooth® Low Energy), Wi-Fi® components, and other communication components), and a power management interface 1420 (e.g., an interface to send/receive power or control signals to/from the PMC 1312.

FIG. 15 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 15 shows a diagrammatic representation of hardware resources 1500 including one or more processors (or processor cores) 1510, one or more memory/storage devices 1520, and one or more communication resources 1530, each of which may be communicatively coupled via a bus 1540. For embodiments where node virtualization (e.g., NFV) is utilized, a hypervisor 1502 may be executed to provide an execution environment for one or more network slices/sub-slices to utilize the hardware resources 1500.

The processors 1510 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) may include, for example, a processor 1512 and a processor 1514.

The memory/storage devices 1520 may include main memory, disk storage, or any suitable combination thereof. The memory/storage devices 1520 may include, but are not limited to any type of volatile or non-volatile memory such as dynamic random-access memory (DRAM), static random-access memory (SRAM), erasable programmable read-only memory (EPROM), electrically erasable programmable read-only memory (EEPROM), Flash memory, solid-state storage, etc.

The communication resources 1530 may include interconnection or network interface components or other suitable devices to communicate with one or more peripheral devices 1504 or one or more databases 1506 via a network 1508. For example, the communication resources 1530 may include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 1550 may comprise software, a program, an application, an applet, an app, or other executable code for causing at least any of the processors 1510 to perform any one or more of the methodologies discussed herein. The instructions 1550 may reside, completely or partially, within at least one of the processors 1510 (e.g., within the processor's cache memory), the memory/storage devices 1520, or any suitable combination thereof. Furthermore, any portion of the instructions 1550 may be transferred to the hardware resources 1500 from any combination of the peripheral devices 1504 or the databases 1506. Accordingly, the memory of processors 1510, the memory/storage devices 1520, the peripheral devices 1504, and the databases 1506 are examples of computer-readable and machine-readable media.

In embodiments, one or more elements of FIGS. 12, 13, 14, and/or 15 may be configured to perform one or more processes, techniques, or methods as described herein, or portions thereof. In embodiments, one or more elements of FIGS. 12, 13, 14, and/or 15 may be configured to perform one or more processes, techniques, or methods, or portions thereof, as described in the following examples.

As used herein, the term “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code to reduce the number of times code must be retrieved from bulk storage during execution. The term “code” covers a broad range of software components and constructs, including applications, drivers, processes, routines, methods, modules, firmware, microcode, and subprograms. Thus, the term “code” may be used to refer to any collection of instructions which, when executed by a processing system, perform a desired operation or operations.

Processing circuitry, logic circuitry, devices, and interfaces herein described may perform functions implemented in hardware and also implemented with code executed on one or more processors. Processing circuitry, or logic circuitry, refers to the hardware or the hardware and code that implements one or more logical functions. Circuitry is hardware and may refer to one or more circuits. Each circuit may perform a particular function. A circuit of the circuitry may comprise discrete electrical components interconnected with one or more conductors, an integrated circuit, a chip package, a chip set, memory, or the like. Integrated circuits include circuits created on a substrate such as a silicon wafer and may comprise components. And integrated circuits, processor packages, chip packages, and chipsets may comprise one or more processors.

Processors may receive signals such as instructions and/or data at the input(s) and process the signals to generate the at least one output. While executing code, the code changes the physical states and characteristics of transistors that make up a processor pipeline. The physical states of the transistors translate into logical bits of ones and zeros stored in registers within the processor. The processor can transfer the physical states of the transistors into registers and transfer the physical states of the transistors to another storage medium.

A processor may comprise circuits or circuitry to perform one or more sub-functions implemented to perform the overall function of “a processor”. Note that “a processor” may comprise one or more processors and each processor may comprise one or more processor cores that independently or interdependently process code and/or data. Each of the processor cores are also “processors” and are only distinguishable from processors for the purpose of describing a physical arrangement or architecture of a processor with multiple processor cores on one or more dies and/or within one or more chip packages. Processor cores may comprise general processing cores or may comprise processor cores configured to perform specific tasks, depending on the design of the processor. Processor cores may be processors with one or more processor cores. As discussed and claimed herein, when discussing functionality performed by a processor, processing circuitry, or the like; the processor, processing circuitry, or the like may comprise one or more processors, each processor having one or more processor cores, and any one or more of the processors and/or processor cores may reside on one or more dies, within one or more chip packages, and may perform part of or all the processing required to perform the functionality.

One example of a processor is a state machine or an application-specific integrated circuit (ASIC) that includes at least one input and at least one output. A state machine may manipulate the at least one input to generate the at least one output by performing a predetermined series of serial and/or parallel manipulations or transformations on the at least one input.

Several embodiments have one or more potentially advantages effects. For instance, triggering a measurement of a CLI may advantageously provide a measurement to identify a CLI. Triggering a CLI-RS by an aggressor base station may advantageously provide a measurement of a CLI. Triggering a periodic, semi-persistent or aperiodic CLI-RS may advantageously determine long term and/or short-term measurements of CLI to identify a mitigation scheme. Transmission of a CLI-RS resource and measurement configuration may advantageously facilitate measurement of CLI by multiple neighboring base stations. Identifying a reference point for a CLI-RS may advantageously facilitate identification of the location of a CLI-RS for measurement. Transmitting a CSI-RS for measurement and identifying the CSI-RS in a CLI-RS resource and measurement configuration may advantageously identify a specific signal to measure for generation of a CLI measurement report. Identifying a CLI-RSSI measurement for a CLI-RS may advantageously identify a RSSI of the CLI to facilitate mitigation. Sharing or transmitting a muting pattern may advantageously facilitate identification of an aggressor base station for a victim base station and improve measurement of the CLI for mitigation. Transmitting a CLI-RS measurement report to one or more neighboring base stations may advantageously facilitate mitigation of CLI. Moving a UE to a different resource for UL may advantageously mitigate CLI for the UL. Informing an aggressor base station of a CLI value in a certain direction at a certain location and/or time within communications on a carrier may advantageously facilitate mitigation of the CLI through modification of transmission power and/or direction by the aggressor base station during the certain location and/or time. Repeatedly measuring a CLI-RS transmitted in multiple sectors may advantageously identify a direction of transmission of DL communications causing the CLI. Repeatedly measuring CLI-RS signals may advantageously identify one or more sectors for receiving UL communications that involve CLI. Measuring L1 CLI-RSRP or CLI-RSSI may advantageously determine dynamic CLI. Measuring L3 CLI-RSRP or CLI-RSSI may advantageously determine long term CLI. Reporting one CLI measurement may advantageously be generated based on a single CLI measurement resource. Reporting more than one CLI measurements may advantageously be shared or transmitted in a single CLI-RS measurement report.

### EXAMPLES OF FURTHER EMBODIMENTS

The following examples pertain to further embodiments. Specifics in the examples may be used anywhere in one or more embodiments.

Example 1 is an apparatus of a first base station for mobile communication to report cross link interference, comprising an interface for backhaul signaling, the interface to receive information on a cross-link interference reference signal (CLI-RS) resource and measurement configuration from a second base station, the CLI-RS resource and measurement configuration to comprise an identification of a communication resource within which to measure a CLI-RS; and send a CLI-RS measurement report to the second base station; and processing circuitry coupled with the interface, the processing circuitry to: measure the CLI-RS based on the identification of the communication resource; and generate the CLI-RS measurement report based on measurement of the CLI-RS and based on a definition for the CLI-RS measurement report. In Example 2, the apparatus of Example 1, wherein the processing circuitry comprises a processor and a memory coupled with the processor, the apparatus further comprising a radio frequency circuitry coupled with the processing circuitry, and one or more antennas coupled with the radio frequency circuitry. In Example 3, the apparatus of Example 1, wherein the first and second base stations are fifth generation (5G) gNodeB (gNBs) and the interface is an Xn interface. In Example 4, the apparatus of Example 1, the definition for the CLI-RS measurement report to comprise a CLI Reference Signal Received Power (CLI-RSRP) or a CLI Received Signal Strength Indicator (CLI-RSSI). In Example 5, the apparatus of Example 1, the identification of the communication resource to comprise a reference subcarrier spacing and a cyclic prefix (CP) length, a point A as a common reference point for a resource block grid, a channel bandwidth, a time and frequency resource for measurement, a bandwidth part (BWP) for transmission of the CLI-RS, a system frame number for the CLI-RS, transmit configuration indicator (TCI) information for the CLI-RS, or a combination thereof, and the CLI-RS resource and measurement configuration identifies a periodic, a semi-persistent, or an aperiodic CLI-RS for generation of the CLI-RS measurement report, wherein the CLI-RS resource and measurement configuration further comprises one or more parameters defining the CLI-RS to identify the CLI-RS based on a channel state information reference signal (CSI-RS) or a sounding reference signal (SRS). In Example 6, the apparatus of Example 1, the definition for the CLI-RS measurement report to comprise a L1 CLI-RS measurement report or a L3 CLI-RS measurement report. In Example 7, the apparatus of any Example 1-6, wherein the identification of the communication resource to comprise information for a configuration of a non-overlapping subband full duplex (SBFD).

Example 8 is a method at a first base station for mobile communication to report a cross link interference, comprising receiving information on a cross-link interference reference signal (CLI-RS) resource and measurement configuration received via an interface from a second base station, the CLI-RS resource and measurement configuration to comprise an identification of a communication resource within which to measure a CLI-RS; measuring, by processing circuitry, the CLI-RS based on the identification of the communication resource; generating, by the processing circuitry, a CLI-RS measurement report based on measurement of the CLI-RS based on a definition for the CLI-RS measurement report; and sending, by the processing circuitry via the interface, the CLI-RS measurement report to the second base station. In Example 9, the method of Example 8, wherein the first and second base stations are fifth generation (5G) gNodeB (gNBs) and the interface is an Xn interface. In Example 10, the method of Example 8, wherein the CLI-RS resource and measurement configuration identifies a CLI Reference Signal Received Power (CLI-RSRP) or a CLI Received Signal Strength Indicator (CLI-RSSI) to define the CLI-RS measurement report; the CLI-RS resource and measurement configuration comprises a reference subcarrier spacing and a cyclic prefix (CP) length, a point A as a common reference point for a resource block grid, a channel bandwidth, a time and frequency resource for measurement, a bandwidth part (BWP) for transmission of the CLI-RS, a system frame number for the CLI-RS, transmit configuration indicator (TCI) information for the CLI-RS, or a combination thereof; the CLI-RS resource and measurement configuration defines the CLI-RS measurement report as a L1 CLI-RS measurement report or a L3 CLI-RS measurement report; and the CLI-RS resource and measurement configuration comprises information for a configuration of a non-overlapping subband full duplex (SBFD) with dynamic TDD operation. In Example 11, the method of any Example 8-10, wherein the CLI-RS resource and measurement configuration identifies a periodic, a semi-persistent, or an aperiodic CLI-RS for generation of the CLI-RS measurement report, wherein the CLI-RS resource and measurement configuration identifies the CLI-RS based on a channel state information reference signal (CSI-RS) or a sounding reference signal (SRS).

Example 12 is a machine-readable medium containing instructions at a first base station for mobile communication, which when executed by a processor, cause the processor to perform operations to report a cross link interference, the operations to receive information on a cross-link interference reference signal (CLI-RS) resource and measurement configuration received via an interface from a second base station, the CLI-RS resource and measurement configuration to comprise an identification of a communication resource within which to measure a CLI-RS; measure, by the processor, the CLI-RS based on the identification of the communication resource; generate, by the processor, a CLI-RS measurement report based on measurement of the CLI-RS based on a definition for the CLI-RS measurement report; and send, by the processor via the interface, the CLI-RS measurement report to the second base station. In Example 13, the machine-readable medium of Example 12, wherein the first and second base stations are fifth generation (5G) gNodeB (gNBs) and the interface is an Xn interface. In Example 14, the machine-readable medium of Example 12, wherein the CLI-RS resource and measurement configuration identifies a CLI Reference Signal Received Power (CLI-RSRP) or a CLI Received Signal Strength Indicator (CLI-RSSI) to define the CLI-RS measurement report; the CLI-RS resource and measurement configuration comprises a reference subcarrier spacing and a cyclic prefix (CP) length, a point A as a common reference point for a resource block grid, a channel bandwidth, a time and frequency resource for measurement, a bandwidth part (BWP) for transmission of the CLI-RS, a system frame number for the CLI-RS, transmit configuration indicator (TCI) information for the CLI-RS, or a combination thereof; the CLI-RS resource and measurement configuration defines the CLI-RS measurement report as a L1 CLI-RS measurement report or a L3 CLI-RS measurement report; and the CLI-RS resource and measurement configuration comprises information for a configuration of a non-overlapping subband full duplex (SBFD) with dynamic TDD operation. In Example 15, the machine-readable medium of any Example 12-14, wherein the CLI-RS resource and measurement configuration identifies a periodic, a semi-persistent, or an aperiodic CLI-RS for generation of the CLI-RS measurement report, wherein the CLI-RS resource and measurement configuration identifies the CLI-RS based on a channel state information reference signal (CSI-RS) or a sounding reference signal (SRS).

Example 16 is an apparatus of a first base station for mobile communication to report a cross link interference, comprising an interface for backhaul signaling; and processing circuitry coupled with the interface to send information on a cross-link interference reference signal (CLI-RS) resource and measurement configuration via an interface to a second base station, the CLI-RS resource and measurement configuration to comprise an identification of a communication resource within which to measure a CLI-RS; cause transmission of the CLI-RS; and receive a CLI-RS measurement report based on measurement of the CLI-RS based on a definition for the CLI-RS measurement report from the second base station via the interface. In Example 17, the apparatus of Example 16, wherein the processing circuitry comprises a processor and a memory coupled with the processor, the apparatus further comprising a radio frequency circuitry coupled with the processing circuitry, and one or more antennas coupled with the radio frequency circuitry. In Example 18, the apparatus of Example 16, wherein the first and second base stations are fifth generation (5G) gNodeB (gNBs) and the interface is an Xn interface. In Example 19, the apparatus of any Example 16-18, the definition for the CLI-RS measurement report to comprise a CLI Reference Signal Received Power (CLI-RSRP) or a CLI Received Signal Strength Indicator (CLI-RSSI); the identification of the communication resource to comprise a reference subcarrier spacing and a cyclic prefix (CP) length, a point A as a common reference point for a resource block grid, a channel bandwidth, a time and frequency resource for measurement, a bandwidth part (BWP) for the transmission of the CLI-RS, a system frame number for the CLI-RS, transmit configuration indicator (TCI) information for the CLI-RS, or a combination thereof; and the CLI-RS resource and measurement configuration to identify a periodic, a semi-persistent, or an aperiodic CLI-RS for generation of the CLI-RS measurement report, wherein the CLI-RS resource and measurement configuration further comprises one or more parameters defining the CLI-RS to identify the CLI-RS based on a channel state information reference signal (CSI-RS) or a sounding reference signal (SRS).

Example 20 is a method of a first base station for mobile communication to report a cross link interference, comprising sending information on a cross-link interference reference signal (CLI-RS) resource and measurement configuration via an interface to a second base station, the CLI-RS resource and measurement configuration to comprise an identification of a communication resource within which to measure a CLI-RS; causing transmission of the CLI-RS; and receiving a CLI-RS measurement report based on measurement of the CLI-RS based on a definition for the CLI-RS measurement report from the second base station via the interface. In Example 21, the method of Example 20, wherein the first and second base stations are fifth generation (5G) gNodeB (gNBs) and the interface is an Xn interface. In Example 22, the method of any Example 20-21, the definition for the CLI-RS measurement report to comprise a CLI Reference Signal Received Power (CLI-RSRP) or a CLI Received Signal Strength Indicator (CLI-RSSI); the identification of the communication resource to comprise a reference subcarrier spacing and a cyclic prefix (CP) length, a point A as a common reference point for a resource block grid, a channel bandwidth, a time and frequency resource for measurement, a bandwidth part (BWP) for the transmission of the CLI-RS, a system frame number for the CLI-RS, transmit configuration indicator (TCI) information for the CLI-RS, or a combination thereof; and the CLI-RS resource and measurement configuration to identify a periodic, a semi-persistent, or an aperiodic CLI-RS for generation of the CLI-RS measurement report, wherein the CLI-RS resource and measurement configuration further comprises one or more parameters defining the CLI-RS to identify the CLI-RS based on a channel state information reference signal (CSI-RS) or a sounding reference signal (SRS).

Example 23 is a machine-readable medium containing instructions at a first base station for mobile communication, which when executed by a processor, cause the processor to perform operations to report a cross link interference, the operations to send information on a cross-link interference reference signal (CLI-RS) resource and measurement configuration via an interface to a second base station, the CLI-RS resource and measurement configuration to comprise an identification of a communication resource within which to measure a CLI-RS; cause transmission of the CLI-RS; and receive a CLI-RS measurement report based on measurement of the CLI-RS based on a definition for the CLI-RS measurement report from the second base station via the interface. In Example 24, the machine-readable medium of Example 23, wherein the identification of the communication resource to comprise information for a configuration of a non-overlapping subband full duplex (SBFD). In Example 25, the machine-readable medium of Example 24, wherein information for the configuration of SBFD includes one or more of an intended DL subband configuration, an intended UL subband configuration, or both, within one or more SBFD symbols, wherein the one or more SBFD symbols comprise at least the identification of frequency resources for UL reception at the first base station; overall frequency resources including both UL reception at and DL transmission from the first base station; one or more guard bands and locations of the one or more guard bands in frequency resources, if guard bands are included in the configuration of the SBFD, within the one or more SBFD symbols; and a time domain location of the one or more SBFD symbols.

Example 26 is an apparatus comprising a means for any Example 8-11.

Example 27 is an apparatus comprising a means for any Example 20-22.

1-25. (canceled)

26. An apparatus of a first base station for mobile communication to report cross link interference, comprising:
an interface for backhaul signaling, the interface to:
receive information on a cross-link interference reference signal (CLI-RS) resource and measurement configuration from a second base station, the CLI-RS resource and measurement configuration to comprise an identification of a communication resource within which to measure a CLI-RS; and
send a CLI-RS measurement report to the second base station; and processing circuitry coupled with the interface, the processing circuitry to:
measure the CLI-RS based on the identification of the communication resource; and
generate the CLI-RS measurement report based on measurement of the CLI-RS and based on a definition for the CLI-RS measurement report.

27. The apparatus of claim 26, wherein the processing circuitry comprises a processor and a memory coupled with the processor, the apparatus further comprising a radio frequency circuitry coupled with the processing circuitry, and one or more antennas coupled with the radio frequency circuitry.

28. The apparatus of claim 26, wherein the first and second base stations are fifth generation (5G) gNodeB (gNBs) and the interface is an Xn interface.

29. The apparatus of claim 26, the definition for the CLI-RS measurement report to comprise a CLI Reference Signal Received Power (CLI-RSRP) or a CLI Received Signal Strength Indicator (CLI-RSSI).

30. The apparatus of claim 26, the identification of the communication resource to comprise a reference subcarrier spacing and a cyclic prefix (CP) length, a point A as a common reference point for a resource block grid, a channel bandwidth, a time and frequency resource for measurement, a bandwidth part (BWP) for transmission of the CLI-RS, a system frame number for the CLI-RS, transmit configuration indicator (TCI) information for the CLI-RS, or a combination thereof; and the CLI-RS resource and measurement configuration identifies a periodic, a semi-persistent, or an aperiodic CLI-RS for generation of the CLI-RS measurement report, wherein the CLI-RS resource and measurement configuration further comprises one or more parameters defining the CLI-RS to identify the CLI-RS based on a channel state information reference signal (CSI-RS) or a sounding reference signal (SRS).

31. The apparatus of claim 26, the definition for the CLI-RS measurement report to comprise a L1 CLI-RS measurement report or a L3 CLI-RS measurement report.

32. The apparatus of claim 26, wherein the identification of the communication resource to comprise information for a configuration of a non-overlapping subband full duplex (SBFD).

33. A machine-readable medium containing instructions at a first base station for mobile communication, which when executed by a processor, cause the processor to perform operations to report a cross link interference, the operations to:
receive information on a cross-link interference reference signal (CLI-RS) resource and measurement configuration received via an interface from a second base station, the CLI-RS resource and measurement configuration to comprise an identification of a communication resource within which to measure a CLI-RS;
measure, by the processor, the CLI-RS based on the identification of the communication resource;
generate, by the processor, a CLI-RS measurement report based on measurement of the CLI-RS based on a definition for the CLI-RS measurement report; and
send, by the processor via the interface, the CLI-RS measurement report to the second base station.

34. The machine-readable medium of claim 33, wherein the first and second base stations are fifth generation (5G) gNodeB (gNBs) and the interface is an Xn interface.

35. The machine-readable medium of claim 33, wherein the CLI-RS resource and measurement configuration identifies a CLI Reference Signal Received Power (CLI-RSRP) or a CLI Received Signal Strength Indicator (CLI-RSSI) to define the CLI-RS measurement report; and
the CLI-RS resource and measurement configuration comprises a reference subcarrier spacing and a cyclic prefix (CP) length, a point A as a common reference point for a resource block grid, a channel bandwidth, a time and frequency resource for measurement, a bandwidth part (BWP) for transmission of the CLI-RS, a system frame number for the CLI-RS, transmit configuration indicator (TCI) information for the CLI-RS, or a combination thereof.

36. The machine-readable medium of claim 33, wherein the CLI-RS resource and measurement configuration identifies a periodic, a semi-persistent, or an aperiodic CLI-RS for generation of the CLI-RS measurement report, wherein the CLI-RS resource and measurement configuration identifies the CLI-RS based on a channel state information reference signal (CSI-RS) or a sounding reference signal (SRS).

37. The machine-readable medium of claim 33, the definition for the CLI-RS measurement report to comprise a L1 CLI-RS measurement report or a L3 CLI-RS measurement report.

38. The machine-readable medium of claim 33, wherein the identification of the communication resource to comprise information for a configuration of a non-overlapping subband full duplex (SBFD).

39. An apparatus of a first base station for mobile communication to report a cross link interference, comprising:
an interface for backhaul signaling; and
processing circuitry coupled with the interface to:
send information on a cross-link interference reference signal (CLI-RS) resource and measurement configuration via an interface to a second base station, the CLI-RS resource and measurement configuration to comprise an identification of a communication resource within which to measure a CLI-RS;
cause transmission of the CLI-RS; and
receive a CLI-RS measurement report based on measurement of the CLI-RS based on a definition for the CLI-RS measurement report from the second base station via the interface.

40. The apparatus of claim 39, wherein the processing circuitry comprises a processor and a memory coupled with the processor, the apparatus further comprising a radio frequency circuitry coupled with the processing circuitry, and one or more antennas coupled with the radio frequency circuitry.

41. The apparatus of claim 39, wherein the first and second base stations are fifth generation (5G) gNodeB (gNBs) and the interface is an Xn interface.

42. The apparatus of claim 39, the definition for the CLI-RS measurement report to comprise a CLI Reference Signal Received Power (CLI-RSRP) or a CLI Received Signal Strength Indicator (CLI-RSSI); the identification of the communication resource to comprise a reference subcarrier spacing and a cyclic prefix (CP) length, a point A as a common reference point for a resource block grid, a channel bandwidth, a time and frequency resource for measurement, a bandwidth part (BWP) for the transmission of the CLI-RS, a system frame number for the CLI-RS, transmit configuration indicator (TCI) information for the CLI-RS, or a combination thereof.

43. The apparatus of claim 42, the CLI-RS resource and measurement configuration to identify a periodic, a semi-persistent, or an aperiodic CLI-RS for generation of the CLI-RS measurement report, wherein the CLI-RS resource and measurement configuration further comprises one or more parameters defining the CLI-RS to identify the CLI-RS based on a channel state information reference signal (CSI-RS) or a sounding reference signal (SRS).

44. The apparatus of claim 39, wherein the identification of the communication resource to comprise information for a configuration of a non-overlapping subband full duplex (SBFD).

45. The apparatus of claim 44, wherein the information for the configuration of the SBFD comprises one or more of:
an intended DL subband configuration, an intended UL subband configuration, or both, within one or more SBFD symbols, wherein the one or more SBFD symbols comprise at least the identification of frequency resources for UL reception at the first base station;
overall frequency resources including both UL reception at and DL transmission from the first base station;
one or more guard bands and locations of the one or more guard bands in frequency resources, if guard bands are included in the configuration of the SBFD, within the one or more SBFD symbols; and
a time domain location of the one or more SBFD symbols.
